(19) United States
(12) Patent Application Publication
(10) Pub. No.: US 2025/0206987 A1
(43) Pub. Date: Jun. 26, 2025

(54) FIRE-RESISTANT ADHESIVES AND RELATED SYSTEMS AND RELATED METHODS

(71) Applicant: BMIC LLC, Dallas, TX (US)

(72) Inventor: Lingtao Yu, Summit, NJ (US)

(21) Appl. No.: 18/991,163

(22) Filed: Dec. 20, 2024

Related U.S. Application Data
(60) Provisional application No. 63/613,259, filed on Dec. 21, 2023.

(51) Int. Cl. C09J 7/30; C08K 3/22; C08K 5/00; C09J 7/22; E04D 5/06; E04D 5/14

(52) U.S. Cl. CPC C09J 7/30; C09J 7/22; E04D 5/06; E04D 5/148; C08K 3/22; C08K 2003/2224; C08K 5/0066; C09J 2203/346; C09J 2301/122; C09J 2301/408

(57) ABSTRACT

Roofing systems are provided. A roofing system comprises a roofing substrate, and a roofing membrane located on the roofing substrate. The roofing membrane comprises a first layer, and a second layer located between the first layer and the roofing substrate. The second layer comprises an adhesive. The adhesive adheres the roofing membrane to the roofing substrate. The adhesive comprises a sufficient amount of fire retardant such that, when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive that does not comprise a fire retardant, or the adhesive exhibits a burn time of less than 15 seconds when tested according to UL 94. Related systems, methods, and materials are also provided.

### CROSS-REFERENCE TO RELATED APPLICATIONS

The present application claims priority to and benefit of U.S. Provisional Patent Application No. 63/613,259, filed Dec. 21, 2023, and entitled “FIRE-RESISTANT ADHESIVES AND RELATED SYSTEMS AND RELATED METHODS,” the entirety of which is herein incorporated by reference.

### FIELD

This disclosure generally relates to fire-resistant adhesives, and related systems and related methods.

### BACKGROUND

Installing roofs is a laborious and time-intensive process. In addition, roofs are exposed to various external environmental conditions, including, for example, wind and precipitation. Roofs are also flammable and pose fire risks.

### SUMMARY

Some embodiments relate to a roofing system. In some embodiments, the roofing system comprises a roofing substrate. In some embodiments, the roofing system comprises a roofing membrane. In some embodiments, the roofing membrane is located on the roofing substrate. In some embodiments, the roofing membrane comprises a first layer. In some embodiments, the roofing membrane comprises a second layer. In some embodiments, the second layer is located between the first layer and the roofing substrate. In some embodiments, the second layer comprises an adhesive. In some embodiments, the adhesive adheres the roofing membrane to the roofing substrate. In some embodiments, the adhesive comprises 0.1% to 20% by weight of a fire retardant based on a total weight of the adhesive. In some embodiments, when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant. In some embodiments, the adhesive exhibits a burn time of less than 15 seconds when tested according to UL 94.

In some embodiments, the first layer comprises a thermoplastic polyolefin (TPO), a polyvinyl chloride (PVC), or an ethylene propylene diene monomer (EPDM).

In some embodiments, the adhesive comprises 0.1% to 15% by weight of the fire retardant based on a total weight of the adhesive.

In some embodiments, the adhesive comprises 0.1% to 10% by weight of the fire retardant based on a total weight of the adhesive.

In some embodiments, the adhesive comprises 0.1% to 5% by weight of the fire retardant based on a total weight of the adhesive.

In some embodiments, the adhesive comprises a fire retardant selected from the group consisting of a polyphosphate, a magnesium hydroxide, a chlorinated olefin, and any combination thereof.

In some embodiments, when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant.

In some embodiments, the second layer, when tested according to UL94, exhibits a burn time of 1 second to 15 seconds.

Some embodiments relate to a roofing membrane. In some embodiments, the roofing membrane comprises a first layer. In some embodiments, the roofing membrane comprises a second layer. In some embodiments, when the roofing membrane is installed on a roofing substrate, the second layer is located between the first layer and the roofing substrate. In some embodiments, the second layer comprises an adhesive. In some embodiments, the adhesive adheres the roofing membrane to the roofing substrate. In some embodiments, the adhesive comprises 0.1% to 20% by weight of a fire retardant based on a total weight of the adhesive. In some embodiments, when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant. In some embodiments, the adhesive exhibits a burn time of less than 15 seconds when tested according to UL 94.

In some embodiments, the first layer comprises a thermoplastic polyolefin (TPO), a polyvinyl chloride (PVC), or an ethylene propylene diene monomer (EPDM).

In some embodiments, the adhesive comprises 0.1% to 15% by weight of the fire retardant based on a total weight of the adhesive.

In some embodiments, the adhesive comprises 0.1% to 10% by weight of the fire retardant based on a total weight of the adhesive.

In some embodiments, the adhesive comprises 0.1% to 5% by weight of the fire retardant based on a total weight of the adhesive.

In some embodiments, the adhesive comprises a fire retardant selected from the group consisting of a polyphosphate, a magnesium hydroxide, a chlorinated olefin, and any combination thereof.

In some embodiments, when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant.

In some embodiments, when the roofing membrane is installed on a roofing substrate, the second layer, when tested according to UL94, exhibits a burn time of 1 second to 15 seconds.

Some embodiments relate to a method of installation. In some embodiments, the method of installation comprises obtaining a roofing membrane. In some embodiments, the roofing membrane comprises a first layer. In some embodiments, the roofing membrane comprises a second layer. In some embodiments, the roofing membrane comprises a release liner. In some embodiments, the second layer is located between the first layer and the release liner. In some embodiments, the release liner covers the second layer. In some embodiments, the second layer comprises an adhesive. In some embodiments, the adhesive comprises 0.1% to 20% by weight of a fire retardant based on a total weight of the adhesive. In some embodiments, the method of installation comprises removing the release liner from the roofing membrane, so as to expose the second layer of the roofing membrane. In some embodiments, the method of installation comprises contacting the second layer of the roofing membrane with a roofing substrate, so as to adhere the roofing membrane to the roofing substrate. In some embodiments, when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant. In some embodiments, the adhesive exhibits a burn time of less than 15 seconds when tested according to UL 94.

In some embodiments, the first layer comprises a thermoplastic polyolefin (TPO), a polyvinyl chloride (PVC), or an ethylene propylene diene monomer (EPDM).

In some embodiments, the adhesive comprises 0.1% to 15% by weight of the fire retardant based on a total weight of the adhesive.

In some embodiments, the adhesive comprises a fire retardant selected from the group consisting of a polyphosphate, a magnesium hydroxide, a chlorinated olefin, and any combination thereof.

Some embodiments relate to a roofing membrane. In some embodiments, the roofing membrane comprises a first layer. In some embodiments, the roofing membrane comprises a second layer. In some embodiments, when the roofing membrane is installed on a roofing substrate, the second layer is located between the first layer and the roofing substrate. In some embodiments, the second layer comprises an adhesive. In some embodiments, the adhesive adheres the roofing membrane to the roofing substrate. In some embodiments, the adhesive comprises a sufficient amount of a fire retardant such that, when the adhesive is installed on a plywood substrate and located between the roofing membrane and the plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant, or a burn time of less than 15 seconds when tested according to UL 94.

### BRIEF DESCRIPTION OF THE DRAWINGS

Reference is made to the drawings that form a part of this disclosure, and which illustrate embodiments in which the materials and methods described herein can be practiced.

FIG. 1 is a schematic diagram of a cross-section of a roofing membrane, according to some embodiments.

FIG. 2 is a schematic diagram of a cross-section of a roofing system, according to some embodiments.

FIG. 3 is a flowchart of a method for installing a roofing membrane, according to some embodiments.

### DETAILED DESCRIPTION

Some embodiments relate to adhesives for roofing materials. In some embodiments, when the adhesives are incorporated into roofing materials, the roofing materials exhibit both improved fire resistance and enhanced adhesion strength. For example, in some embodiments, the adhesives comprise a fire retardant. In some embodiments, when the fire retardant is incorporated into the adhesive, the adhesive improves the fire resistance performance of the roofing material and related systems. In some embodiments, when the fire retardant is incorporated into the adhesive, the adhesive forms a fire block layer that prevents the fire from spreading further. In some embodiments, in addition to improving the fire resistance performance of the roofing material, the presence of the fire retardant in the adhesive enhances the adhesive strength between, for example, the roofing material and a roofing substrate. In some embodiments, the adhesives exhibit enhanced adhesive strength between dissimilar materials, including materials for which achieving sufficient adhesion is difficult using conventional adhesives. In some embodiments, in addition to improving fire resistance performance of the roofing materials and related systems, the adhesives also enhance wind uplift resistance performance.

Some embodiments relate to an adhesive. In some embodiments, the adhesive comprises a hot-melt adhesive. In some embodiments, the adhesive comprises a solvent-based adhesive. In some embodiments, the adhesive comprises a pressure-sensitive adhesive. In some embodiments, the adhesive comprises a water-based adhesive. In some embodiments, the adhesive comprises a curable adhesive. In some embodiments, the adhesive comprises an ultraviolet light (UV)-curable adhesive. In some embodiments, the adhesive comprises a heat-curable adhesive. In some embodiments, the adhesive comprises a moisture-curable adhesive. In some embodiments, the adhesive comprises a low volatile organic compound (VOC) adhesive. In some embodiments, the adhesive comprises at least one of a hot-melt adhesive, a solvent-based adhesive, a pressure-sensitive adhesive, a water-based adhesive, a curable adhesive, a UV-curable adhesive, a heat-curable adhesive, a moisture-curable adhesive, a low volatile organic compound adhesive, or any combination thereof.

In some embodiments, the adhesive comprises a fire retardant.

In some embodiments, the fire retardant comprises at least one of a halogenated fire retardant, a polyphosphate, a magnesium hydroxide, a chlorinated olefin, a chlorinated paraffin, or any combination thereof. In some embodiments, the fire retardant comprises at least one of a phosphate, a phosphorus, a phosphite, a hypophosphite, a melamine, a clay, a metal hydroxide, a metal oxide, a borate, a urea, or any combination thereof. In some embodiments, the fire retardant comprises at least one of an ammonium pyrophosphate, an ammonium polyphosphate, a diethyl phosphinate, an ethylene diamine phosphate, a melamine pyrophosphate, a melamine polyzinc phosphate, a melamine polymagnesium phosphate, a melamine zinc phosphate, a piperazine phosphate, a pyrophosphoric acid salt, a hydroxyphenyl phosphinyl propanoic acid, a magnesium hydroxide, an alumina trihydrate, a melamine cyanurate, a zinc borate, a manganese borate, an ammonium borate, a lead borate, an expandable graphite, a graphene, tetrabromobisphenol A, decabromodiphenyl oxide, antimony trioxide, a phosphate ester, or any combination thereof.

In some embodiments, the adhesive comprises 0.1% to 25% by weight of the fire retardant based on a total weight of the adhesive. In some embodiments, the adhesive comprises 0.1% to 24% by weight of the fire retardant based on a total weight of the adhesive. In some embodiments, the adhesive comprises 0.1% to 23% by weight of the fire retardant based on a total weight of the adhesive. In some embodiments, the adhesive comprises 0.1% to 22% by weight of the fire retardant based on a total weight of the adhesive. In some embodiments, the adhesive comprises 0.1% to 21% by weight of the fire retardant based on a total weight of the adhesive. In some embodiments, the adhesive comprises 0.1% to 20% by weight of the fire retardant based on a total weight of the adhesive. In some embodiments, the adhesive comprises 0.1% to 20% by weight of the fire retardant based on a total weight of the adhesive. In some embodiments, the adhesive comprises 0.1% to 19% by weight of the fire retardant based on the total weight of the adhesive. In some embodiments, the adhesive comprises 0.1% to 18% by weight of the fire retardant based on the total weight of the adhesive. In some embodiments, the adhesive comprises 0.1% to 17% by weight of the fire retardant based on the total weight of the adhesive. In some embodiments, the adhesive comprises 0.1% to 16% by weight of the fire retardant based on the total weight of the adhesive. In some embodiments, the adhesive comprises 0.1% to 15% by weight of the fire retardant based on the total weight of the adhesive. In some embodiments, the adhesive comprises 0.1% to 14% by weight of the fire retardant based on the total weight of the adhesive. In some embodiments, the adhesive comprises 0.1% to 13% by weight of the fire retardant based on the total weight of the adhesive. In some embodiments, the adhesive comprises 0.1% to 12% by weight of the fire retardant based on the total weight of the adhesive. In some embodiments, the adhesive comprises 0.1% to 11% by weight of the fire retardant based on the total weight of the adhesive. In some embodiments, the adhesive comprises 0.1% to 10% by weight of the fire retardant based on the total weight of the adhesive. In some embodiments, the adhesive comprises 0.1% to 9.5% by weight of the fire retardant based on the total weight of the adhesive. In some embodiments, the adhesive comprises 0.1% to 9% by weight of the fire retardant based on the total weight of the adhesive. In some embodiments, the adhesive comprises 0.1% to 8.5% by weight of the fire retardant based on the total weight of the adhesive. In some embodiments, the adhesive comprises 0.1% to 8% by weight of the fire retardant based on the total weight of the adhesive. In some embodiments, the adhesive comprises 0.1% to 7.5% by weight of the fire retardant based on the total weight of the adhesive. In some embodiments, the adhesive comprises 0.1% to 7% by weight of the fire retardant based on the total weight of the adhesive. In some embodiments, the adhesive comprises 0.1% to 6.5% by weight of the fire retardant based on the total weight of the adhesive. In some embodiments, the adhesive comprises 0.1% to 6% by weight of the fire retardant based on the total weight of the adhesive. In some embodiments, the adhesive comprises 0.1% to 5.5% by weight of the fire retardant based on the total weight of the adhesive. In some embodiments, the adhesive comprises 0.1% to 5% by weight of the fire retardant based on the total weight of the adhesive. In some embodiments, the adhesive comprises 0.1% to 4.5% by weight of the fire retardant based on the total weight of the adhesive. In some embodiments, the adhesive comprises 0.1% to 4% by weight of the fire retardant based on the total weight of the adhesive. In some embodiments, the adhesive comprises 0.1% to 3.5% by weight of the fire retardant based on the total weight of the adhesive. In some embodiments, the adhesive comprises 0.1% to 3% by weight of the fire retardant based on the total weight of the adhesive. In some embodiments, the adhesive comprises 0.1% to 2.5% by weight of the fire retardant based on the total weight of the adhesive. In some embodiments, the adhesive comprises 0.1% to 2% by weight of the fire retardant based on the total weight of the adhesive. In some embodiments, the adhesive comprises 0.1% to 1.5% by weight of the fire retardant based on the total weight of the adhesive. In some embodiments, the adhesive comprises 0.1% to 1% by weight of the fire retardant based on the total weight of the adhesive. In some embodiments, the adhesive comprises 0.1% to 0.5% by weight of the fire retardant based on the total weight of the adhesive.

In some embodiments, the adhesive comprises 1% to 20% by weight of the fire retardant based on the total weight of the adhesive. In some embodiments, the adhesive comprises 2% to 20% by weight of the fire retardant based on the total weight of the adhesive. In some embodiments, the adhesive comprises 3% to 20% by weight of the fire retardant based on the total weight of the adhesive. In some embodiments, the adhesive comprises 4% to 20% by weight of the fire retardant based on the total weight of the adhesive. In some embodiments, the adhesive comprises 5% to 20% by weight of the fire retardant based on the total weight of the adhesive. In some embodiments, the adhesive comprises 6% to 20% by weight of the fire retardant based on the total weight of the adhesive. In some embodiments, the adhesive comprises 7% to 20% by weight of the fire retardant based on the total weight of the adhesive. In some embodiments, the adhesive comprises 8% to 20% by weight of the fire retardant based on the total weight of the adhesive. In some embodiments, the adhesive comprises 9% to 20% by weight of the fire retardant based on the total weight of the adhesive. In some embodiments, the adhesive comprises 10% to 20% by weight of the fire retardant based on the total weight of the adhesive. In some embodiments, the adhesive comprises 11% to 20% by weight of the fire retardant based on the total weight of the adhesive. In some embodiments, the adhesive comprises 12% to 20% by weight of the fire retardant based on the total weight of the adhesive. In some embodiments, the adhesive comprises 13% to 20% by weight of the fire retardant based on the total weight of the adhesive. In some embodiments, the adhesive comprises 14% to 20% by weight of the fire retardant based on the total weight of the adhesive. In some embodiments, the adhesive comprises 15% to 20% by weight of the fire retardant based on the total weight of the adhesive. In some embodiments, the adhesive comprises 16% to 20% by weight of the fire retardant based on the total weight of the adhesive. In some embodiments, the adhesive comprises 17% to 20% by weight of the fire retardant based on the total weight of the adhesive. In some embodiments, the adhesive comprises 18% to 20% by weight of the fire retardant based on the total weight of the adhesive. In some embodiments, the adhesive comprises 19% to 20% by weight of the fire retardant based on the total weight of the adhesive.

In some embodiments, the adhesive comprises 1% to 10% by weight of the fire retardant based on the total weight of the adhesive. In some embodiments, the adhesive comprises 2% to 10% by weight of the fire retardant based on the total weight of the adhesive. In some embodiments, the adhesive comprises 3% to 10% by weight of the fire retardant based on the total weight of the adhesive. In some embodiments, the adhesive comprises 4% to 10% by weight of the fire retardant based on the total weight of the adhesive. In some embodiments, the adhesive comprises 5% to 10% by weight of the fire retardant based on the total weight of the adhesive. In some embodiments, the adhesive comprises 6% to 10% by weight of the fire retardant based on the total weight of the adhesive. In some embodiments, the adhesive comprises 7% to 10% by weight of the fire retardant based on the total weight of the adhesive. In some embodiments, the adhesive comprises 8% to 10% by weight of the fire retardant based on the total weight of the adhesive. In some embodiments, the adhesive comprises 9% to 10% by weight of the fire retardant based on the total weight of the adhesive.

In some embodiments, the adhesive comprises 0.5% to 5% by weight of the fire retardant based on the total weight of the adhesive. In some embodiments, the adhesive comprises 1% to 5% by weight of the fire retardant based on the total weight of the adhesive. In some embodiments, the adhesive comprises 1.5% to 5% by weight of the fire retardant based on the total weight of the adhesive. In some embodiments, the adhesive comprises 2% to 5% by weight of the fire retardant based on the total weight of the adhesive. In some embodiments, the adhesive comprises 2.5% to 5% by weight of the fire retardant based on the total weight of the adhesive. In some embodiments, the adhesive comprises 3% to 5% by weight of the fire retardant based on the total weight of the adhesive. In some embodiments, the adhesive comprises 3.5% to 5% by weight of the fire retardant based on the total weight of the adhesive. In some embodiments, the adhesive comprises 4% to 5% by weight of the fire retardant based on the total weight of the adhesive. In some embodiments, the adhesive comprises 4.5% to 5% by weight of the fire retardant based on the total weight of the adhesive.

In some embodiments, the adhesive comprises a polymer.

In some embodiments, the polymer comprises at least one of an elastomer, a polyolefin, a resin, a thermoset, a thermoplastic, or any combination thereof. In some embodiments, the polymer comprises at least one of a thermosetting polyolefin, thermoplastic polyolefin (TPO), a silyl-modified polymer, a silane-terminated polymer, a natural rubber, a poly-alpha-olefin (APAO/APO) polymer, a polyamide polyvinyl acetate, a polyvinyl alcohol, a polyamide, a polyester, a polyester amide, a polyvinyl butyrate, a polysiloxane or a silicone, a polychloroprene, a polycarbonate, a polyurethane, an asphalt, a butyl, an epoxy, a rubber, a butyl rubber, a polystyrene, a styrenic copolymer (e.g., a styrenic block copolymer), a styrene-butadiene-styrene (SBS), a styrene-isoprene-styrene (SIS), a styrene butadiene (SB), a styrene-ethylene-butadiene-styrene (SEBS), an ethylene vinyl acetate (EVA), a polyvinyl acetate, an acrylic, a vinyl acetate acrylic, an ethylene vinyl acetate, an ethylene acrylic, a styrene acrylic, a vinyl chloride acrylic, a vinyl versatate, any copolymer thereof, or any combination thereof. In some embodiments, the polymer is different from the fire retardant. In some embodiments, the polymer does not comprise any one or more of the polymers disclosed herein. In some embodiments, the polymer does not comprise an acrylic polymer. In some embodiments, the polymer does not comprise a meth (acrylic) polymer.

In some embodiments, the adhesive comprises 0.5% to 50% by weight of a polymer based on a total weight of the adhesive. In some embodiments, the adhesive comprises 0.5% to 48% by weight of the polymer based on the total weight of the adhesive. In some embodiments, the adhesive comprises 0.5% to 46% by weight of the polymer based on the total weight of the adhesive. In some embodiments, the adhesive comprises 0.5% to 45% by weight of the polymer based on the total weight of the adhesive. In some embodiments, the adhesive comprises 0.5% to 44% by weight of the polymer based on the total weight of the adhesive. In some embodiments, the adhesive comprises 0.5% to 42% by weight of the polymer based on the total weight of the adhesive. In some embodiments, the adhesive comprises 0.5% to 40% by weight of the polymer based on the total weight of the adhesive. In some embodiments, the adhesive comprises 0.5% to 38% by weight of the polymer based on the total weight of the adhesive. In some embodiments, the adhesive comprises 0.5% to 36% by weight of the polymer based on the total weight of the adhesive. In some embodiments, the adhesive comprises 0.5% to 35% by weight of the polymer based on the total weight of the adhesive. In some embodiments, the adhesive comprises 0.5% to 34% by weight of the polymer based on the total weight of the adhesive. In some embodiments, the adhesive comprises 0.5% to 32% by weight of the polymer based on the total weight of the adhesive. In some embodiments, the adhesive comprises 0.5% to 30% by weight of the polymer based on the total weight of the adhesive. In some embodiments, the adhesive comprises 0.5% to 28% by weight of the polymer based on the total weight of the adhesive. In some embodiments, the adhesive comprises 0.5% to 26% by weight of the polymer based on the total weight of the adhesive. In some embodiments, the adhesive comprises 0.5% to 25% by weight of the polymer based on the total weight of the adhesive. In some embodiments, the adhesive comprises 0.5% to 24% by weight of the polymer based on the total weight of the adhesive. In some embodiments, the adhesive comprises 0.5% to 22% by weight of the polymer based on the total weight of the adhesive. In some embodiments, the adhesive comprises 0.5% to 20% by weight of the polymer based on the total weight of the adhesive. In some embodiments, the adhesive comprises 0.5% to 18% by weight of the polymer based on the total weight of the adhesive. In some embodiments, the adhesive comprises 0.5% to 16% by weight of the polymer based on the total weight of the adhesive. In some embodiments, the adhesive comprises 0.5% to 15% by weight of the polymer based on the total weight of the adhesive. In some embodiments, the adhesive comprises 0.5% to 14% by weight of the polymer based on the total weight of the adhesive. In some embodiments, the adhesive comprises 0.5% to 12% by weight of the polymer based on the total weight of the adhesive. In some embodiments, the adhesive comprises 0.5% to 10% by weight of the polymer based on the total weight of the adhesive. In some embodiments, the adhesive comprises 0.5% to 8% by weight of the polymer based on the total weight of the adhesive. In some embodiments, the adhesive comprises 0.5% to 6% by weight of the polymer based on the total weight of the adhesive. In some embodiments, the adhesive comprises 0.5% to 5% by weight of the polymer based on the total weight of the adhesive. In some embodiments, the adhesive comprises 0.5% to 4% by weight of the polymer based on the total weight of the adhesive. In some embodiments, the adhesive comprises 0.5% to 2% by weight of the polymer based on the total weight of the adhesive.

In some embodiments, the adhesive comprises 1% to 50% by weight of the polymer based on the total weight of the adhesive. In some embodiments, the adhesive comprises 2% to 50% by weight of the polymer based on the total weight of the adhesive. In some embodiments, the adhesive comprises 4% to 50% by weight of the polymer based on the total weight of the adhesive. In some embodiments, the adhesive comprises 5% to 50% by weight of the polymer based on the total weight of the adhesive. In some embodiments, the adhesive comprises 6% to 50% by weight of the polymer based on the total weight of the adhesive. In some embodiments, the adhesive comprises 8% to 50% by weight of the polymer based on the total weight of the adhesive. In some embodiments, the adhesive comprises 10% to 50% by weight of the polymer based on the total weight of the adhesive. In some embodiments, the adhesive comprises 12% to 50% by weight of the polymer based on the total weight of the adhesive. In some embodiments, the adhesive comprises 14% to 50% by weight of the polymer based on the total weight of the adhesive. In some embodiments, the adhesive comprises 15% to 50% by weight of the polymer based on the total weight of the adhesive. In some embodiments, the adhesive comprises 16% to 50% by weight of the polymer based on the total weight of the adhesive. In some embodiments, the adhesive comprises 18% to 50% by weight of the polymer based on the total weight of the adhesive. In some embodiments, the adhesive comprises 20% to 50% by weight of the polymer based on the total weight of the adhesive. In some embodiments, the adhesive comprises 22% to 50% by weight of the polymer based on the total weight of the adhesive. In some embodiments, the adhesive comprises 24% to 50% by weight of the polymer based on the total weight of the adhesive. In some embodiments, the adhesive comprises 25% to 50% by weight of the polymer based on the total weight of the adhesive. In some embodiments, the adhesive comprises 26% to 50% by weight of the polymer based on the total weight of the adhesive. In some embodiments, the adhesive comprises 28% to 50% by weight of the polymer based on the total weight of the adhesive. In some embodiments, the adhesive comprises 30% to 50% by weight of the polymer based on the total weight of the adhesive. In some embodiments, the adhesive comprises 32% to 50% by weight of the polymer based on the total weight of the adhesive. In some embodiments, the adhesive comprises 34% to 50% by weight of the polymer based on the total weight of the adhesive. In some embodiments, the adhesive comprises 35% to 50% by weight of the polymer based on the total weight of the adhesive. In some embodiments, the adhesive comprises 36% to 50% by weight of the polymer based on the total weight of the adhesive. In some embodiments, the adhesive comprises 38% to 50% by weight of the polymer based on the total weight of the adhesive. In some embodiments, the adhesive comprises 40% to 50% by weight of the polymer based on the total weight of the adhesive. In some embodiments, the adhesive comprises 42% to 50% by weight of the polymer based on the total weight of the adhesive. In some embodiments, the adhesive comprises 44% to 50% by weight of the polymer based on the total weight of the adhesive. In some embodiments, the adhesive comprises 45% to 50% by weight of the polymer based on the total weight of the adhesive. In some embodiments, the adhesive comprises 46% to 50% by weight of the polymer based on the total weight of the adhesive. In some embodiments, the adhesive comprises 48% to 50% by weight of the polymer based on the total weight of the adhesive.

In some embodiments, the adhesive comprises a crosslinker.

In some embodiments, the crosslinker comprises a neutral curing agent. In some embodiments, the crosslinker comprises at least one of ketoxime silanes, alkoxysilanes, acetoxysilanes, isopropenoxy silanes, a partial hydrolysate/condensate of said silanes, or any combination thereof. In some embodiments, the crosslinker comprises an organosilane, which may contain at least 2 or at least 3 hydrolyzable groups in one molecule and/or its partial hydrolysate. In some embodiments, a hydrolyzable group in such an organosilane or its partial hydrolysate includes at least one of a ketoxime group, an alkoxy group, an acetoxy group, an isopropenoxy group, or any combination thereof. In some embodiments, the crosslinker comprises an organic titanate, a thermal radical initiator, a UV radical initiator, or any combination thereof. In some embodiments, the crosslinker comprises ketoxime silanes. In some embodiments, a ketoxime silane comprises at least one of tetrakis(methylethylketoxime)silane, methyltris(dimethylketoxime)silane, methyltris(methylethylketoxime)silane, ethyltris(methylethylketoxime)silane, methyltris(methyl isobutyl ketoxime)silane, vinyl tris(methylethylketoxime)silane or any combination thereof. In some embodiments, the crosslinker comprises an alkoxysilane. In some embodiments, the alkoxysilane comprises at least one of methyltrimethoxysilane, vinyltrimethoxysilane, phenyltrimethoxysilane, vinyltriethoxy silane, or any combination thereof. In some embodiments, the crosslinker comprises an acetoxysilane. In some embodiments, the acetoxysilane comprises at least one of methyltriacetoxysilane, vinyltriacetoxysilane, or any combination thereof. In some embodiments, the crosslinker comprises an isopropenoxy silane. In some embodiments, the isopropenoxy silane comprises at least one of methyltriisopropenoxysilane, vinyltriisopropenoxysilane, phenyltriisopropenoxysilane, or any combination thereof. In some embodiments, the crosslinker comprises a partial hydrolysate/condensate of any one of the silanes disclosed herein. In some embodiments, the crosslinker comprises at least one of methyltris(methylethylketoxime)silane, vinyltris(methylethylketoxime)silane, or any combination thereof. In some embodiments, the crosslinker is different from the fire retardant.

In some embodiments, the adhesive comprises 0.1% to 40% by weight of the crosslinker based on the total weight of the adhesive. In some embodiments, the adhesive comprises 0.1% to 35% by weight of the crosslinker based on the total weight of the adhesive. In some embodiments, the adhesive comprises 0.1% to 30% by weight of the crosslinker based on the total weight of the adhesive. In some embodiments, the adhesive comprises 0.1% to 25% by weight of the crosslinker based on the total weight of the adhesive. In some embodiments, the adhesive comprises 0.1% to 20% by weight of the crosslinker based on the total weight of the adhesive. In some embodiments, the adhesive comprises 0.1% to 15% by weight of the crosslinker based on the total weight of the adhesive. In some embodiments, the adhesive comprises 0.1% to 10% by weight of the crosslinker based on the total weight of the adhesive. In some embodiments, the adhesive comprises 0.1% to 9% by weight of the crosslinker based on the total weight of the adhesive. In some embodiments, the adhesive comprises 0.1% to 8% by weight of the crosslinker based on the total weight of the adhesive. In some embodiments, the adhesive comprises 0.1% to 7% by weight of the crosslinker based on the total weight of the adhesive. In some embodiments, the adhesive comprises 0.1% to 6% by weight of the crosslinker based on the total weight of the adhesive. In some embodiments, the adhesive comprises 0.1% to 5% by weight of the crosslinker based on the total weight of the adhesive. In some embodiments, the adhesive comprises 0.1% to 4% by weight of the crosslinker based on the total weight of the adhesive. In some embodiments, the adhesive comprises 0.1% to 3% by weight of the crosslinker based on the total weight of the adhesive. In some embodiments, the adhesive comprises 0.1% to 2% by weight of the crosslinker based on the total weight of the adhesive. In some embodiments, the adhesive comprises 0.1% to 1% by weight of the crosslinker based on the total weight of the adhesive.

In some embodiments, the adhesive comprises 1% to 40% by weight of the crosslinker based on the total weight of the adhesive. In some embodiments, the adhesive comprises 5% to 40% by weight of the crosslinker based on the total weight of the adhesive. In some embodiments, the adhesive comprises 10% to 40% by weight of the crosslinker based on the total weight of the adhesive. In some embodiments, the adhesive comprises 15% to 40% by weight of the crosslinker based on the total weight of the adhesive. In some embodiments, the adhesive comprises 20% to 40% by weight of the crosslinker based on the total weight of the adhesive. In some embodiments, the adhesive comprises 25% to 40% by weight of the crosslinker based on the total weight of the adhesive. In some embodiments, the adhesive comprises 30% to 40% by weight of the crosslinker based on the total weight of the adhesive. In some embodiments, the adhesive comprises 35% to 40% by weight of the crosslinker based on the total weight of the adhesive.

In some embodiments, the adhesive comprises a catalyst.

In some embodiments, the catalyst comprises at least one of an organic tin, an organic platinum, triethanolamine titanate, dimethyltin dioleate, dibutyltin diacetate, stannous octoate, dibutyltin dioctoate, dibutyltin dilaurate, dibutyltin dimethoxide, dibutyltin bis(acetylacetonate), dibutyltin bis(benzylmalate), dimethyltin dimethoxide, dimethyltin diacetate, dioctyltin dioctate, dioctyltin dilaurate, tin dioctate, tin laurate, tetraisopropyl titanate, tetra-n-butyl titanate, tetra-tertiary butyl titanate, tetra-n-propyl titanate, tetra-2-ethylhexyl titanate, diisopropyl di-tertiary butyl titanate, dimethoxy titanium bisacetylacetonate, diisopropoxy titanium bisethyl acetoacetate, di-tertiary butoxy titanium bisethyl acetoacetate, di-tertiary butoxy titanium bismethyl acetoacetate, or any combination thereof. In some embodiments, the catalyst is different from the fire retardant.

In some embodiments, the adhesive comprises 0.1% to 15% by weight of the catalyst based on the total weight of the adhesive. In some embodiments, the adhesive comprises 0.1% to 14% by weight of the catalyst based on the total weight of the adhesive. In some embodiments, the adhesive comprises 0.1% to 13% by weight of the catalyst based on the total weight of the adhesive. In some embodiments, the adhesive comprises 0.1% to 12% by weight of the catalyst based on the total weight of the adhesive. In some embodiments, the adhesive comprises 0.1% to 11% by weight of the catalyst based on the total weight of the adhesive. In some embodiments, the adhesive comprises 0.1% to 10% by weight of the catalyst based on the total weight of the adhesive. In some embodiments, the adhesive comprises 0.1% to 9% by weight of the catalyst based on the total weight of the adhesive. In some embodiments, the adhesive comprises 0.1% to 8% by weight of the catalyst based on the total weight of the adhesive. In some embodiments, the adhesive comprises 0.1% to 7% by weight of the catalyst based on the total weight of the adhesive. In some embodiments, the adhesive comprises 0.1% to 6% by weight of the catalyst based on the total weight of the adhesive. In some embodiments, the adhesive comprises 0.1% to 5% by weight of the catalyst based on the total weight of the adhesive. In some embodiments, the adhesive comprises 0.1% to 4% by weight of the catalyst based on the total weight of the adhesive. In some embodiments, the adhesive comprises 0.1% to 3% by weight of the catalyst based on the total weight of the adhesive. In some embodiments, the adhesive comprises 0.1% to 2% by weight of the catalyst based on the total weight of the adhesive. In some embodiments, the adhesive comprises 0.1% to 1% by weight of the catalyst based on the total weight of the adhesive.

In some embodiments, the adhesive comprises 2% to 15% by weight of the catalyst based on the total weight of the adhesive. In some embodiments, the adhesive comprises 3% to 15% by weight of the catalyst based on the total weight of the adhesive. In some embodiments, the adhesive comprises 4% to 15% by weight of the catalyst based on the total weight of the adhesive. In some embodiments, the adhesive comprises 5% to 15% by weight of the catalyst based on the total weight of the adhesive. In some embodiments, the adhesive comprises 6% to 15% by weight of the catalyst based on the total weight of the adhesive. In some embodiments, the adhesive comprises 7% to 15% by weight of the catalyst based on the total weight of the adhesive. In some embodiments, the adhesive comprises 8% to 15% by weight of the catalyst based on the total weight of the adhesive. In some embodiments, the adhesive comprises 9% to 15% by weight of the catalyst based on the total weight of the adhesive. In some embodiments, the adhesive comprises 10% to 15% by weight of the catalyst based on the total weight of the adhesive. In some embodiments, the adhesive comprises 11% to 15% by weight of the catalyst based on the total weight of the adhesive. In some embodiments, the adhesive comprises 12% to 15% by weight of the catalyst based on the total weight of the adhesive. In some embodiments, the adhesive comprises 13% to 15% by weight of the catalyst based on the total weight of the adhesive. In some embodiments, the adhesive comprises 14% to 15% by weight of the catalyst based on the total weight of the adhesive.

In some embodiments, the adhesive comprises an adhesion promoter.

In some embodiments, the adhesion promoter comprises at least one of dichlorodimethyl silane, a chlorinated polyolefin, an organosilane, an organotitanate, a zircoaluminate, a zirconate, an acrylate, an aryl phosphate ester, an alkyl phosphate ester, an aryl alkyl phosphate ester, a metal organic, a silica, a fumed silica, N-(2-aminoethyl)-3-aminopropyltrimethoxysilane, vinyl tris(2-methoxyethoxy)silane, 3-methacryloxypropyltrimethoxysilane, 2-(3,4-epoxycyclohexyl)ethyl trimethoxysilane, 3-glycidoxypropyltrimethoxysilane, 3-glycidoxypropylmethyldiethoxysilane, N-(2-aminoethyl) 3-aminopropyltrimethoxysilane, 3-aminopropyltriethoxysilane, 3-(N-aminomethylbenzylamino) propyltrimethoxysilane, 3-mercaptopropyltrimethoxysilane, 3-aminopropyltris(methylethylketoxime)silane, 3-glycidoxy propyltriisopropenoxysilane, 3-glycidoxypropylmethyldiisopropenoxysilane, any reaction product thereof, or any combination thereof. In some embodiments, the adhesion promoter is a reaction product of dichlorodimethylsilane and a silica agent. In some embodiments, the silica agent comprises a fumed silica. In some embodiments, the adhesion promoter comprises at least one of tetraethyl orthosilicate, aminopropyltrimethoxysilane, or any combination thereof. In some embodiments, the adhesion promoter is different from the fire retardant.

In some embodiments, the adhesive comprises 0.1% to 20% by weight of the adhesion promoter based on the total weight of the adhesive. In some embodiments, the adhesive comprises 0.1% to 19% by weight of the adhesion promoter based on the total weight of the adhesive. In some embodiments, the adhesive comprises 0.1% to 18% by weight of the adhesion promoter based on the total weight of the adhesive. In some embodiments, the adhesive comprises 0.1% to 17% by weight of the adhesion promoter based on the total weight of the adhesive. In some embodiments, the adhesive comprises 0.1% to 16% by weight of the adhesion promoter based on the total weight of the adhesive. In some embodiments, the adhesive comprises 0.1% to 15% by weight of the adhesion promoter based on the total weight of the adhesive. In some embodiments, the adhesive comprises 0.1% to 14% by weight of the adhesion promoter based on the total weight of the adhesive. In some embodiments, the adhesive comprises 0.1% to 13% by weight of the adhesion promoter based on the total weight of the adhesive. In some embodiments, the adhesive comprises 0.1% to 12% by weight of the adhesion promoter based on the total weight of the adhesive. In some embodiments, the adhesive comprises 0.1% to 11% by weight of the adhesion promoter based on the total weight of the adhesive. In some embodiments, the adhesive comprises 0.1% to 10% by weight of the adhesion promoter based on the total weight of the adhesive. In some embodiments, the adhesive comprises 0.1% to 9% by weight of the adhesion promoter based on the total weight of the adhesive. In some embodiments, the adhesive comprises 0.1% to 8% by weight of the adhesion promoter based on the total weight of the adhesive. In some embodiments, the adhesive comprises 0.1% to 7% by weight of the adhesion promoter based on the total weight of the adhesive. In some embodiments, the adhesive comprises 0.1% to 6% by weight of the adhesion promoter based on the total weight of the adhesive. In some embodiments, the adhesive comprises 0.1% to 5% by weight of the adhesion promoter based on the total weight of the adhesive. In some embodiments, the adhesive comprises 0.1% to 4% by weight of the adhesion promoter based on the total weight of the adhesive. In some embodiments, the adhesive comprises 0.1% to 3% by weight of the adhesion promoter based on the total weight of the adhesive. In some embodiments, the adhesive comprises 0.1% to 2% by weight of the adhesion promoter based on the total weight of the adhesive. In some embodiments, the adhesive comprises 0.1% to 1% by weight of the adhesion promoter based on the total weight of the adhesive.

In some embodiments, the adhesive comprises 1% to 20% by weight of the adhesion promoter based on the total weight of the adhesive. In some embodiments, the adhesive comprises 2% to 20% by weight of the adhesion promoter based on the total weight of the adhesive. In some embodiments, the adhesive comprises 3% to 20% by weight of the adhesion promoter based on the total weight of the adhesive. In some embodiments, the adhesive comprises 4% to 20% by weight of the adhesion promoter based on the total weight of the adhesive. In some embodiments, the adhesive comprises 5% to 20% by weight of the adhesion promoter based on the total weight of the adhesive. In some embodiments, the adhesive comprises 6% to 20% by weight of the adhesion promoter based on the total weight of the adhesive. In some embodiments, the adhesive comprises 7% to 20% by weight of the adhesion promoter based on the total weight of the adhesive. In some embodiments, the adhesive comprises 8% to 20% by weight of the adhesion promoter based on the total weight of the adhesive. In some embodiments, the adhesive comprises 9% to 20% by weight of the adhesion promoter based on the total weight of the adhesive. In some embodiments, the adhesive comprises 10% to 20% by weight of the adhesion promoter based on the total weight of the adhesive. In some embodiments, the adhesive comprises 11% to 20% by weight of the adhesion promoter based on the total weight of the adhesive. In some embodiments, the adhesive comprises 12% to 20% by weight of the adhesion promoter based on the total weight of the adhesive. In some embodiments, the adhesive comprises 13% to 20% by weight of the adhesion promoter based on the total weight of the adhesive. In some embodiments, the adhesive comprises 14% to 20% by weight of the adhesion promoter based on the total weight of the adhesive. In some embodiments, the adhesive comprises 15% to 20% by weight of the adhesion promoter based on the total weight of the adhesive. In some embodiments, the adhesive comprises 16% to 20% by weight of the adhesion promoter based on the total weight of the adhesive. In some embodiments, the adhesive comprises 17% to 20% by weight of the adhesion promoter based on the total weight of the adhesive. In some embodiments, the adhesive comprises 18% to 20% by weight of the adhesion promoter based on the total weight of the adhesive. In some embodiments, the adhesive comprises 19% to 20% by weight of the adhesion promoter based on the total weight of the adhesive.

In some embodiments, the adhesive comprises a filler.

In some embodiments, the filler comprises at least one of nepheline syenite, magnesium oxide, zinc oxide, calcium carbonate, barium sulfate, iron oxide, diatomaceous earth, melamine, quartz, silica, colloidal silica, crystalline silica, precipitated silica, amorphous silica, titanium dioxide, alumina trihydrate, zinc oxide, zirconium oxide, zirconium silicate, zinc borate, chromic oxide, crystalline silica fine powder, amorphous silica fine powder, silicone rubber powder, glass, glass bubbles, glass powder, zeolites, silica hydrogen, silica aero gel, calcium silicate, aluminum silicate, aluminum oxide, ferrite, carbon black, graphite, mica, clay, bentonite, ground quartz, kaolin, calcined kaolin, wollastonite, hydroxyapatite, hydrated alumina, magnesium hydroxide, vermiculite, talcum, slaked lime, or any combination thereof. In some embodiments, the filler is different from the fire retardant.

In some embodiments, the adhesive comprises 0.1% to 50% by weight of the filler based on the total weight of the adhesive. In some embodiments, the adhesive comprises 0.1% to 45% by weight of the filler based on the total weight of the adhesive. In some embodiments, the adhesive comprises 0.1% to 40% by weight of the filler based on the total weight of the adhesive. In some embodiments, the adhesive comprises 0.1% to 35% by weight of the filler based on the total weight of the adhesive. In some embodiments, the adhesive comprises 0.1% to 30% by weight of the filler based on the total weight of the adhesive. In some embodiments, the adhesive comprises 0.1% to 25% by weight of the filler based on the total weight of the adhesive. In some embodiments, the adhesive comprises 0.1% to 20% by weight of the filler based on the total weight of the adhesive. In some embodiments, the adhesive comprises 0.1% to 15% by weight of the filler based on the total weight of the adhesive. In some embodiments, the adhesive comprises 0.1% to 10% by weight of the filler based on the total weight of the adhesive. In some embodiments, the adhesive comprises 0.1% to 9.5% by weight of the filler based on the total weight of the adhesive. In some embodiments, the adhesive comprises 0.1% to 9% by weight of the filler based on the total weight of the adhesive. In some embodiments, the adhesive comprises 0.1% to 8.5% by weight of the filler based on the total weight of the adhesive. In some embodiments, the adhesive comprises 0.1% to 8% by weight of the filler based on the total weight of the adhesive. In some embodiments, the adhesive comprises 0.1% to 7.5% by weight of the filler based on the total weight of the adhesive. In some embodiments, the adhesive comprises 0.1% to 7% by weight of the filler based on the total weight of the adhesive. In some embodiments, the adhesive comprises 0.1% to 6.5% by weight of the filler based on the total weight of the adhesive. In some embodiments, the adhesive comprises 0.1% to 6% by weight of the filler based on the total weight of the adhesive. In some embodiments, the adhesive comprises 0.1% to 5.5% by weight of the filler based on the total weight of the adhesive. In some embodiments, the adhesive comprises 0.1% to 5% by weight of the filler based on the total weight of the adhesive. In some embodiments, the adhesive comprises 0.1% to 4.5% by weight of the filler based on the total weight of the adhesive. In some embodiments, the adhesive comprises 0.1% to 4% by weight of the filler based on the total weight of the adhesive. In some embodiments, the adhesive comprises 0.1% to 3.5% by weight of the filler based on the total weight of the adhesive. In some embodiments, the adhesive comprises 0.1% to 3% by weight of the filler based on the total weight of the adhesive. In some embodiments, the adhesive comprises 0.1% to 2.5% by weight of the filler based on the total weight of the adhesive. In some embodiments, the adhesive comprises 0.1% to 2% by weight of the filler based on the total weight of the adhesive. In some embodiments, the adhesive comprises 0.1% to 1.5% by weight of the filler based on the total weight of the adhesive. In some embodiments, the adhesive comprises 0.1% to 1% by weight of the filler based on the total weight of the adhesive. In some embodiments, the adhesive comprises 0.1% to 0.5% by weight of the filler based on the total weight of the adhesive.

In some embodiments, the adhesive comprises 1% to 50% by weight of the filler based on the total weight of the adhesive. In some embodiments, the adhesive comprises 5% to 50% by weight of the filler based on the total weight of the adhesive. In some embodiments, the adhesive comprises 10% to 50% by weight of the filler based on the total weight of the adhesive. In some embodiments, the adhesive comprises 15% to 50% by weight of the filler based on the total weight of the adhesive. In some embodiments, the adhesive comprises 20% to 50% by weight of the filler based on the total weight of the adhesive. In some embodiments, the adhesive comprises 25% to 50% by weight of the filler based on the total weight of the adhesive. In some embodiments, the adhesive comprises 30% to 50% by weight of the filler based on the total weight of the adhesive. In some embodiments, the adhesive comprises 35% to 50% by weight of the filler based on the total weight of the adhesive. In some embodiments, the adhesive comprises 40% to 50% by weight of the filler based on the total weight of the adhesive. In some embodiments, the adhesive comprises 45% to 50% by weight of the filler based on the total weight of the adhesive.

In some embodiments, the adhesive comprises an additive.

In some embodiments, the additive comprises at least one of a tackifier, a plasticizer, an antioxidant, a pigment, a colorant, a dye, a binding agent, an antistatic agent, a stabilizer a UV stabilizer, a fiber, a surfactant, an oil, a hydrocarbon oil, a process oil, a hydrocarbon resin, a rosin resin, a resin, a wax, a natural wax, a petroleum wax, or any combination thereof. In some embodiments, the additive is different from the fire retardant. For example, in some embodiments, the plasticizer is different from the fire retardant. In some embodiments, the tackifier is different from the fire retardant. In some embodiments, the adhesive does not comprise any one or more of the additives disclosed herein. For example, in some embodiments, the adhesive does not comprise a plasticizer.

In some embodiments, the adhesive comprises 0.1% to 40% by weight of the additive based on the total weight of the adhesive. In some embodiments, the adhesive comprises 0.1% to 35% by weight of the additive based on the total weight of the adhesive. In some embodiments, the adhesive comprises 0.1% to 30% by weight of the additive based on the total weight of the adhesive. In some embodiments, the adhesive comprises 0.1% to 25% by weight of the additive based on the total weight of the adhesive. In some embodiments, the adhesive comprises 0.1% to 20% by weight of the additive based on the total weight of the adhesive. In some embodiments, the adhesive comprises 0.1% to 15% by weight of the additive based on the total weight of the adhesive. In some embodiments, the adhesive comprises 0.1% to 10% by weight of the additive based on the total weight of the adhesive. In some embodiments, the adhesive comprises 0.1% to 9% by weight of the additive based on the total weight of the adhesive. In some embodiments, the adhesive comprises 0.1% to 8% by weight of the additive based on the total weight of the adhesive. In some embodiments, the adhesive comprises 0.1% to 7% by weight of the additive based on the total weight of the adhesive. In some embodiments, the adhesive comprises 0.1% to 6% by weight of the additive based on the total weight of the adhesive. In some embodiments, the adhesive comprises 0.1% to 5% by weight of the additive based on the total weight of the adhesive. In some embodiments, the adhesive comprises 0.1% to 4% by weight of the additive based on the total weight of the adhesive. In some embodiments, the adhesive comprises 0.1% to 3% by weight of the additive based on the total weight of the adhesive. In some embodiments, the adhesive comprises 0.1% to 2% by weight of the additive based on the total weight of the adhesive. In some embodiments, the adhesive comprises 0.1% to 1% by weight of the additive based on the total weight of the adhesive.

In some embodiments, the adhesive comprises 1% to 40% by weight of the additive based on the total weight of the adhesive. In some embodiments, the adhesive comprises 5% to 40% by weight of the additive based on the total weight of the adhesive. In some embodiments, the adhesive comprises 10% to 40% by weight of the additive based on the total weight of the adhesive. In some embodiments, the adhesive comprises 15% to 40% by weight of the additive based on the total weight of the adhesive. In some embodiments, the adhesive comprises 20% to 40% by weight of the additive based on the total weight of the adhesive. In some embodiments, the adhesive comprises 25% to 40% by weight of the additive based on the total weight of the adhesive. In some embodiments, the adhesive comprises 30% to 40% by weight of the additive based on the total weight of the adhesive. In some embodiments, the adhesive comprises 35% to 40% by weight of the additive based on the total weight of the adhesive.

In some embodiments, the adhesive comprises a solvent.

In some embodiments, the solvent comprises at least one of a volatile solvent, a nonvolatile solvent, an organic solvent, an inert solvent, an inorganic solvent, a water, or any combination thereof. In some embodiments, the solvent comprises at least one of an ester, a hydrocarbon, a ketone, an aromatic hydrocarbon, or any combination thereof. In some embodiments, the solvent comprises at least one of a hexane, an ethyl acetate, a butyl acetate, a methoxpropylacetate, an acetone, a methyl ethyl ketone, a methyl isobutyl ketone, a cyclohexanone, a toluene, a xylene, a naptha, an isopropyl alcohol, or any combination thereof.

In some embodiments, the adhesive comprises 1% to 80% by weight of a solvent based on the total weight of the adhesive. In some embodiments, the adhesive comprises 1% to 75% by weight of a solvent based on the total weight of the adhesive. In some embodiments, the adhesive comprises 1% to 70% by weight of a solvent based on the total weight of the adhesive. In some embodiments, the adhesive comprises 1% to 65% by weight of a solvent based on the total weight of the adhesive. In some embodiments, the adhesive comprises 1% to 60% by weight of a solvent based on the total weight of the adhesive. In some embodiments, the adhesive comprises 1% to 55% by weight of a solvent based on the total weight of the adhesive. In some embodiments, the adhesive comprises 1% to 50% by weight of a solvent based on the total weight of the adhesive. In some embodiments, the adhesive comprises 1% to 45% by weight of a solvent based on the total weight of the adhesive. In some embodiments, the adhesive comprises 1% to 40% by weight of a solvent based on the total weight of the adhesive. In some embodiments, the adhesive comprises 1% to 35% by weight of a solvent based on the total weight of the adhesive. In some embodiments, the adhesive comprises 1% to 30% by weight of a solvent based on the total weight of the adhesive. In some embodiments, the adhesive comprises 1% to 25% by weight of a solvent based on the total weight of the adhesive. In some embodiments, the adhesive comprises 1% to 20% by weight of a solvent based on the total weight of the adhesive. In some embodiments, the adhesive comprises 1% to 15% by weight of a solvent based on the total weight of the adhesive. In some embodiments, the adhesive comprises 1% to 10% by weight of a solvent based on the total weight of the adhesive. In some embodiments, the adhesive comprises 1% to 5% by weight of a solvent based on the total weight of the adhesive.

In some embodiments, the adhesive comprises 5% to 80% by weight of a solvent based on the total weight of the adhesive. In some embodiments, the adhesive comprises 10% to 80% by weight of a solvent based on the total weight of the adhesive. In some embodiments, the adhesive comprises 15% to 80% by weight of a solvent based on the total weight of the adhesive. In some embodiments, the adhesive comprises 20% to 80% by weight of a solvent based on the total weight of the adhesive. In some embodiments, the adhesive comprises 25% to 80% by weight of a solvent based on the total weight of the adhesive. In some embodiments, the adhesive comprises 30% to 80% by weight of a solvent based on the total weight of the adhesive. In some embodiments, the adhesive comprises 35% to 80% by weight of a solvent based on the total weight of the adhesive. In some embodiments, the adhesive comprises 40% to 80% by weight of a solvent based on the total weight of the adhesive. In some embodiments, the adhesive comprises 45% to 80% by weight of a solvent based on the total weight of the adhesive. In some embodiments, the adhesive comprises 50% to 80% by weight of a solvent based on the total weight of the adhesive. In some embodiments, the adhesive comprises 55% to 80% by weight of a solvent based on the total weight of the adhesive. In some embodiments, the adhesive comprises 60% to 80% by weight of a solvent based on the total weight of the adhesive. In some embodiments, the adhesive comprises 65% to 80% by weight of a solvent based on the total weight of the adhesive. In some embodiments, the adhesive comprises 70% to 80% by weight of a solvent based on the total weight of the adhesive. In some embodiments, the adhesive comprises 75% to 80% by weight of a solvent based on the total weight of the adhesive.

In some embodiments, the adhesive is provided in a form of an adhesive layer. In some embodiments, the adhesive is provided in a form of an adhesive composition. In some embodiments, the adhesive is provided in a form of a cured adhesive composition. In some embodiments, the adhesive is provided in a form of a reaction product. In some embodiments, the adhesive is provided in a form of a crosslinked adhesive composition. In some embodiments, the adhesive is provided in a form of a flowable adhesive composition. In some embodiments, the adhesive is provided in a form of a single adhesive layer. In some embodiments, for example, the adhesive layer comprises an adhesive through an entire thickness of the adhesive layer. In some embodiments, the adhesive is provided in a form of an adhesive film. In some embodiments, the adhesive film comprises one or more layers. In some embodiments, the adhesive film comprises at least one of a first layer, a second layer, a third layer, a fourth layer, a fifth layer, a sixth layer, a seventh layer, an eighth layer, a ninth layer, a tenth layer, or any combination thereof. In some embodiments, at least two of the one or more layers of the adhesive film are different. In some embodiments, at least two of the one or more layers of the adhesive film are the same. In some embodiments, at least one of the one or more layers of the adhesive film comprise a barrier layer, a tie layer, a polymer layer, a reinforcement layer, or any combination thereof.

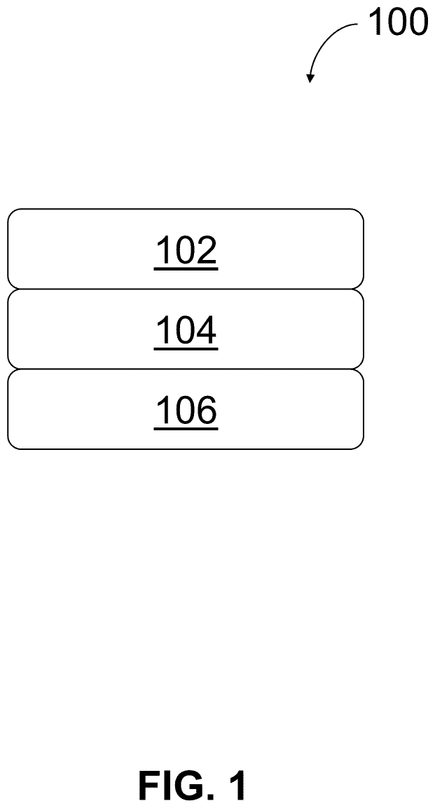

FIG. 1 is a schematic diagram of a cross-section of a roofing membrane 100, according to some embodiments.

In some embodiments, the roofing membrane 100 is a single layer membrane. In some embodiments, the roofing membrane 100 is a multi-layer membrane. In some embodiments, the roofing membrane 100 is an extruded roofing membrane. In some embodiments, the roofing membrane 100 is a laminated roofing membrane. In some embodiments, the roofing membrane 100 is a molded roofing membrane. In some embodiments, the roofing membrane 100 is a reinforced roofing membrane. In some embodiments, the roofing membrane 100 is a self-adhering roofing membrane. In some embodiments, for example, the roofing membrane 100 comprises at least one of a mesh, a fabric, a fleece, a mat (a woven mat, an unwoven mat, etc.), a scrim, a coated scrim, a woven, a non-woven, or any combination thereof. In some embodiments, the roofing membrane 100 is an unreinforced roofing membrane. In some embodiments, the roofing membrane 100 is provided in the form of a roll of a roofing membrane.

As shown in FIG. 1, in some embodiments, the roofing membrane 100 comprises at least one layer. For example, in some embodiments, the roofing membrane 100 comprises a first layer 102. In some embodiments, the roofing membrane 100 comprises a second layer 104. In some embodiments, the roofing membrane 100 comprises a release liner 106. In some embodiments, the second layer 104 is located between the first layer 102 and the release liner 106. In some embodiments, the second layer 104 directly contacts the first layer 102. In some embodiments, the second layer 104 directly contacts the release liner 106. In some embodiments, when the roofing membrane 100 is installed, the release liner 106 is removed. In some embodiments, when the roofing membrane 100 is installed, the second layer 104 is configured to be located between the first layer 102 and a roofing substrate (not shown). In some embodiments, when the roofing membrane 100 is installed, the second layer 104 is configured to directly contact the roofing substrate. In some embodiments, when the roofing membrane 100 is installed, the second layer 104 is configured to adhere the roofing membrane 100 to the roofing substrate.

In some embodiments, the first layer 102 comprises a polymer. In some embodiments, the polymer comprises at least one of a crosslinkable polymer, a crosslinked polymer, a non-crosslinked polymer, or any combination thereof. In some embodiments, the polymer comprises at least one of a thermoplastic polyolefin (TPO), a polyvinyl chloride (PVC), an ethylene propylene diene monomer (EPDM), a polysiloxane, a silyl-terminated polymer (STP), or any combination thereof. In some embodiments, the polymer comprises at least one of a linear polysiloxane, a cyclic polysiloxane, a branched polysiloxane, a silyl-terminated polyurethane, a silyl-terminated polyether, a silyl-terminated acrylic, a silyl-terminated polyester, polyester, polyethylene, polypropylene, polyurethane, polyurea, or any combination thereof. In some embodiments, the at least one polymer comprises at least one of a liquid silicone resin, a liquid silicone rubber resin (LSR), a heat cured silicone resin, a silicone gum, or any combination thereof. In some embodiments, the at least one polymer comprises at least one of a linear polysiloxane, a cyclic polysiloxane, a branched polysiloxane, polyester, polyethylene, polypropylene, polyurethane, polyurea, a liquid silicone resin, a liquid silicone rubber resin (LSR), a heat cured silicone resin, a silicone gum, a polyolefin, a polycarbonate, a polyether, a silyl-terminated polyurethane, a silyl-terminated polyether, a silyl-terminated acrylic, a silyl-terminated polyester, or any combination thereof.

In some embodiments, the second layer 104 comprises an adhesive. It will be appreciated that the adhesive may comprise any one or more of the adhesives disclosed herein. For example, in some embodiments, the second layer comprises an adhesive. In some embodiments, the adhesive comprises a fire retardant. In some embodiments, for example, the adhesive comprises 0.1% to 20% by weight of a fire retardant based on a total weight of the adhesive.

It will be appreciated that the roofing membrane 100 may comprise at least one additional layer (i.e., in addition to the first layer and/or the second layer). For example, in some embodiments, the roofing membrane 100 further comprises one (1) to one-hundred (100) additional layers. In some embodiments, for example, the roofing membrane 100 comprises a third layer, a fourth layer, a fifth layer, a sixth layer, a seventh layer, an eighth layer, a ninth layer, a tenth layer, and so on, up to, for example and without limitation, a hundredth layer. In some embodiments, the at least one additional layer comprises at least one of a polymer layer, a reinforcement layer, an adhesive layer, a tie layer, an intervening layer, a metal layer, a barrier layer, or any combination thereof. In some embodiments, the at least one additional layer is on a first side of the first layer 102, and the second layer 104 is on a second side opposite the first side. In some embodiments, the at least one additional layer is located between the first layer 102 and the second layer 104. In some embodiments, the at least one additional layer directly contacts the first layer 102. In some embodiments, the at least one additional layer directly contacts the second layer 104.

In some embodiments, for example, the roofing membrane 100 further comprises a reinforcement layer. In some embodiments, the reinforcement layer is embedded in the first layer. In some embodiments, the reinforcement layer is located between the first layer 102 and the second layer 104. In some embodiments, the reinforcement layer directly contacts the first layer 102. In some embodiments, the reinforcement layer directly contacts the second layer 104. In some embodiments, the reinforcement layer is located between the first layer 102 and a third layer (not shown), wherein the third layer is located between the reinforcement layer and the second layer 104. In some embodiments, the reinforcement layer directly contacts the first layer 102. In some embodiments, the reinforcement layer directly contacts the third layer. In some embodiments, the third layer directly contacts the second layer 104.

In some embodiments, the reinforcement layer comprises at least one of a scrim, a mat, a woven, a nonwoven, a fabric, or any combination thereof. In some embodiments, the reinforcement layer comprises at least one of a spunbond mat, a spunlaced mat, an airlaid mat, a meltblown mat, or any combination thereof. In some embodiments, the reinforcement layer comprises a fibrous material, wherein the fibrous material comprises at least one of a natural fiber, a synthetic fiber, or any combination thereof. In some embodiments, the reinforcement layer comprises at least one of a polyolefin (e.g., at least one of a polyethylene, a polypropylene, any copolymer thereof, any blend thereof, or any combination thereof), a polyester, a polyamide, a glass, a fiberglass, or any combination thereof.

In some embodiments, the first layer 102 has a thickness of 1 mil to 100 mils. In some embodiments, the first layer 102 has a thickness of 1 mil to 90 mils. In some embodiments, the first layer 102 has a thickness of 1 mil to 80 mils. In some embodiments, the first layer 102 has a thickness of 1 mil to 70 mils. In some embodiments, the first layer 102 has a thickness of 1 mil to 60 mils. In some embodiments, the first layer 102 has a thickness of 1 mil to 50 mils. In some embodiments, the first layer 102 has a thickness of 1 mil to 40 mils. In some embodiments, the first layer 102 has a thickness of 1 mil to 30 mils. In some embodiments, the first layer 102 has a thickness of 1 mil to 20 mils. In some embodiments, the first layer 102 has a thickness of 1 mil to 10 mils.

In some embodiments, the first layer 102 has a thickness of 10 mils to 100 mils. In some embodiments, the first layer 102 has a thickness of 20 mils to 100 mils. In some embodiments, the first layer 102 has a thickness of 30 mils to 100 mils. In some embodiments, the first layer 102 has a thickness of 40 mils to 100 mils. In some embodiments, the first layer 102 has a thickness of 50 mils to 100 mils. In some embodiments, the first layer 102 has a thickness of 60 mils to 100 mils. In some embodiments, the first layer 102 has a thickness of 70 mils to 100 mils. In some embodiments, the first layer 102 has a thickness of 80 mils to 100 mils. In some embodiments, the first layer 102 has a thickness of 90 mils to 100 mils.

In some embodiments, the second layer 104 has a thickness of 1 mil to 100 mils. In some embodiments, the second layer 104 has a thickness of 1 mil to 90 mils. In some embodiments, the second layer 104 has a thickness of 1 mil to 80 mils. In some embodiments, the second layer 104 has a thickness of 1 mil to 70 mils. In some embodiments, the second layer 104 has a thickness of 1 mil to 60 mils. In some embodiments, the second layer 104 has a thickness of 1 mil to 50 mils. In some embodiments, the second layer 104 has a thickness of 1 mil to 40 mils. In some embodiments, the second layer 104 has a thickness of 1 mil to 30 mils. In some embodiments, the second layer 104 has a thickness of 1 mil to 20 mils. In some embodiments, the second layer 104 has a thickness of 1 mil to 10 mils.

In some embodiments, the second layer 104 has a thickness of 20 mils to 100 mils. In some embodiments, the second layer 104 has a thickness of 30 mils to 100 mils. In some embodiments, the second layer 104 has a thickness of 40 mils to 100 mils. In some embodiments, the second layer 104 has a thickness of 50 mils to 100 mils. In some embodiments, the second layer 104 has a thickness of 60 mils to 100 mils. In some embodiments, the second layer 104 has a thickness of 70 mils to 100 mils. In some embodiments, the second layer 104 has a thickness of 80 mils to 100 mils. In some embodiments, the second layer 104 has a thickness of 90 mils to 100 mils.

In some embodiments, the roofing membrane 100 has a thickness of 2 mils to 200 mils. In some embodiments, the roofing membrane 100 has a thickness of 5 mils to 200 mils. In some embodiments, the roofing membrane 100 has a thickness of 10 mils to 200 mils. In some embodiments, the roofing membrane 100 has a thickness of 20 mils to 200 mils. In some embodiments, the roofing membrane 100 has a thickness of 30 mils to 200 mils. In some embodiments, the roofing membrane 100 has a thickness of 40 mils to 200 mils. In some embodiments, the roofing membrane 100 has a thickness of 50 mils to 200 mils. In some embodiments, the roofing membrane 100 has a thickness of 60 mils to 200 mils. In some embodiments, the roofing membrane 100 has a thickness of 70 mils to 200 mils. In some embodiments, the roofing membrane 100 has a thickness of 80 mils to 200 mils. In some embodiments, the roofing membrane 100 has a thickness of 90 mils to 200 mils. In some embodiments, the roofing membrane 100 has a thickness of 100 mils to 200 mils. In some embodiments, the roofing membrane 100 has a thickness of 110 mils to 200 mils. In some embodiments, the roofing membrane 100 has a thickness of 120 mils to 200 mils. In some embodiments, the roofing membrane 100 has a thickness of 130 mils to 200 mils. In some embodiments, the roofing membrane 100 has a thickness of 140 mils to 200 mils. In some embodiments, the roofing membrane 100 has a thickness of 150 mils to 200 mils. In some embodiments, the roofing membrane 100 has a thickness of 160 mils to 200 mils. In some embodiments, the roofing membrane 100 has a thickness of 170 mils to 200 mils. In some embodiments, the roofing membrane 100 has a thickness of 180 mils to 200 mils. In some embodiments, the roofing membrane 100 has a thickness of 190 mils to 200 mils.

In some embodiments, the roofing membrane 100 has a thickness of 2 mils to 190 mils. In some embodiments, the roofing membrane 100 has a thickness of 2 mils to 180 mils. In some embodiments, the roofing membrane 100 has a thickness of 2 mils to 170 mils. In some embodiments, the roofing membrane 100 has a thickness of 2 mils to 160 mils. In some embodiments, the roofing membrane 100 has a thickness of 2 mils to 150 mils. In some embodiments, the roofing membrane 100 has a thickness of 2 mils to 140 mils. In some embodiments, the roofing membrane 100 has a thickness of 2 mils to 130 mils. In some embodiments, the roofing membrane 100 has a thickness of 2 mils to 120 mils. In some embodiments, the roofing membrane 100 has a thickness of 2 mils to 110 mils. In some embodiments, the roofing membrane 100 has a thickness of 2 mils to 100 mils. In some embodiments, the roofing membrane 100 has a thickness of 2 mils to 90 mils. In some embodiments, the roofing membrane 100 has a thickness of 2 mils to 80 mils. In some embodiments, the roofing membrane 100 has a thickness of 2 mils to 70 mils. In some embodiments, the roofing membrane 100 has a thickness of 2 mils to 60 mils. In some embodiments, the roofing membrane 100 has a thickness of 2 mils to 50 mils. In some embodiments, the roofing membrane 100 has a thickness of 2 mils to 40 mils. In some embodiments, the roofing membrane 100 has a thickness of 2 mils to 30 mils. In some embodiments, the roofing membrane 100 has a thickness of 2 mils to 20 mils. In some embodiments, the roofing membrane 100 has a thickness of 2 mils to 10 mils. In some embodiments, the roofing membrane 100 has a thickness of 2 mils to 5 mils.

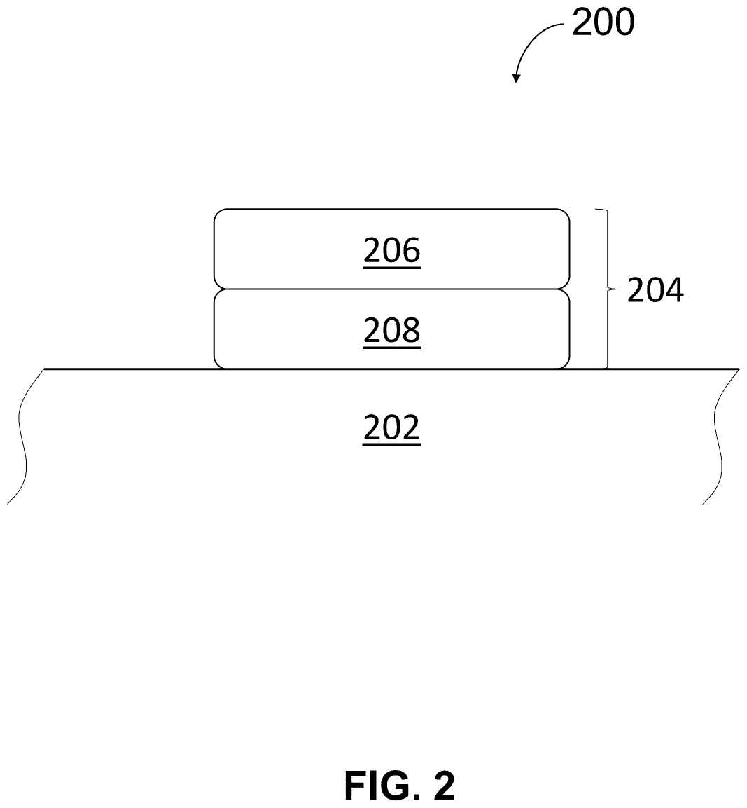

FIG. 2 is a schematic diagram of a cross-section of a roofing system 200, according to some embodiments. As shown in FIG. 2, in some embodiments, the roofing system 200 comprises a roofing substrate 202. In some embodiments, the roofing system 200 comprises a roofing membrane 204. In some embodiments, the roofing membrane 204 is located on the roofing substrate 202. In some embodiments, the roofing membrane 204 covers the roofing substrate 202. In some embodiments, the roofing membrane 204 directly contacts the roofing substrate 202.

In some embodiments, the roofing substrate 202 comprises at least one of an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a building structure, a high density cover board, a cement board, concrete, a base sheet, a pipe, a chimney, a wax paper, a roof shingle, a mat, a fabric, a glass mat, a fiberglass mat, a woven mat, a nonwoven mat, a fabric, a polyester mat, a scrim, a coated scrim, or any combination thereof.

In some embodiments, the roofing membrane 204 comprises any one or more of the roofing membranes disclosed herein. For example, in some embodiments, the roofing membrane 204 comprises a first layer 206 and a second layer 208. In some embodiments, the second layer 208 comprises an adhesive. In some embodiments, the adhesive comprises a fire retardant. In some embodiments, the second layer 208 is located between the first layer 206 and the roofing substrate 202. In some embodiments, the second layer 208 directly contacts the first layer 206. In some embodiments, the second layer 208 directly contacts the roofing substrate 202. In some embodiments, the second layer 208 comprises an adhesive. In some embodiments, the adhesive of the second layer 208 adheres the roofing membrane 204 to the roofing substrate 202.

In some embodiments, the roofing system 200 further comprises an intervening layer located between the second layer 208 and the roofing substrate 202. In some embodiments, the intervening layer comprises a primer layer. In some embodiments, the intervening layer comprises a fleece layer. In some embodiments, the intervening layer comprises a tie layer. In some embodiments, the intervening layer comprises any one or more of the layers disclosed herein. In some embodiments, the roofing system 200 does not comprise any intervening layer located between the second layer 208 and the roofing substrate 202.

In some embodiments, the second layer 208 or the adhesive exhibits a 180° peel strength between the roofing membrane 204 and the roofing substrate 202 of at least 5 PLI when tested at 2″/min pulling speed in accordance with ASTM D413. In some embodiments, the second layer exhibits a 180° peel strength between the roofing membrane 204 and the roofing substrate 202 of at least 6 PLI when tested at 2″/min pulling speed in accordance with ASTM D413. In some embodiments, the second layer exhibits a 180° peel strength between the roofing membrane 204 and the roofing substrate 202 of at least 8 PLI when tested at 2″/min pulling speed in accordance with ASTM D413. In some embodiments, the second layer exhibits a 180° peel strength between the roofing membrane 204 and the roofing substrate 202 of at least 10 PLI when tested at 2″/min pulling speed in accordance with ASTM D413. In some embodiments, the second layer exhibits a 180° peel strength between the roofing membrane 204 and the roofing substrate 202 of at least 12 PLI when tested at 2″/min pulling speed in accordance with ASTM D413. In some embodiments, the second layer exhibits a 180° peel strength between the roofing membrane 204 and the roofing substrate 202 of at least 14 PLI when tested at 2″/min pulling speed in accordance with ASTM D413. In some embodiments, the second layer exhibits a 180° peel strength between the roofing membrane 204 and the roofing substrate 202 of at least 16 PLI when tested at 2″/min pulling speed in accordance with ASTM D413. In some embodiments, the second layer exhibits a 180° peel strength between the roofing membrane 204 and the roofing substrate 202 of at least 18 PLI when tested at 2″/min pulling speed in accordance with ASTM D413. In some embodiments, the second layer exhibits a 180° peel strength between the roofing membrane 204 and the roofing substrate 202 of at least 20 PLI when tested at 2″/min pulling speed in accordance with ASTM D413. In some embodiments, the second layer exhibits a 180° peel strength between the roofing membrane 204 and the roofing substrate 202 of at least 22 PLI when tested at 2″/min pulling speed in accordance with ASTM D413. In some embodiments, the second layer exhibits a 180° peel strength between the roofing membrane 204 and the roofing substrate 202 of at least 24 PLI when tested at 2″/min pulling speed in accordance with ASTM D413.

In some embodiments, the 180° peel strength between the roofing membrane 204 and the roofing substrate 202 is 10 PLI to 25 PLI when tested at 2″/min pulling speed in accordance with ASTM D413. In some embodiments, the 180° peel strength between the roofing membrane 204 and the roofing substrate 202 is 10 PLI to 24 PLI when tested at 2″/min pulling speed in accordance with ASTM D413. In some embodiments, the 180° peel strength between the roofing membrane 204 and the roofing substrate 202 is 10 PLI to 22 PLI when tested at 2″/min pulling speed in accordance with ASTM D413. In some embodiments, the 180° peel strength between the roofing membrane 204 and the roofing substrate 202 is 10 PLI to 20 PLI when tested at 2″/min pulling speed in accordance with ASTM D413. In some embodiments, the 180° peel strength between the roofing membrane 204 and the roofing substrate 202 is 10 PLI to 18 PLI when tested at 2″/min pulling speed in accordance with ASTM D413. In some embodiments, the 180° peel strength between the roofing membrane 204 and the roofing substrate 202 is 10 PLI to 16 PLI when tested at 2″/min pulling speed in accordance with ASTM D413. In some embodiments, the 180° peel strength between the roofing membrane 204 and the roofing substrate 202 is 10 PLI to 14 PLI when tested at 2″/min pulling speed in accordance with ASTM D413. In some embodiments, the 180° peel strength between the roofing membrane 204 and the roofing substrate 202 is 10 PLI to 12 PLI when tested at 2″/min pulling speed in accordance with ASTM D413.

In some embodiments, the 180° peel strength between the roofing membrane 204 and the roofing substrate 202 is 5 PLI to 25 PLI when tested at 2″/min pulling speed in accordance with ASTM D413. In some embodiments, the 180° peel strength between the roofing membrane 204 and the roofing substrate 202 is 6 PLI to 25 PLI when tested at 2″/min pulling speed in accordance with ASTM D413. In some embodiments, the 180° peel strength between the roofing membrane 204 and the roofing substrate 202 is 8 PLI to 25 PLI when tested at 2″/min pulling speed in accordance with ASTM D413. In some embodiments, the 180° peel strength between the roofing membrane 204 and the roofing substrate 202 is 10 PLI to 25 PLI when tested at 2″/min pulling speed in accordance with ASTM D413. In some embodiments, the 180° peel strength between the roofing membrane 204 and the roofing substrate 202 is 12 PLI to 25 PLI when tested at 2″/min pulling speed in accordance with ASTM D413. In some embodiments, the 180° peel strength between the roofing membrane 204 and the roofing substrate 202 is 14 PLI to 25 PLI when tested at 2″/min pulling speed in accordance with ASTM D413. In some embodiments, the 180° peel strength between the roofing membrane 204 and the roofing substrate 202 is 16 PLI to 25 PLI when tested at 2″/min pulling speed in accordance with ASTM D413. In some embodiments, the 180° peel strength between the roofing membrane 204 and the roofing substrate 202 is 18 PLI to 25 PLI when tested at 2″/min pulling speed in accordance with ASTM D413. In some embodiments, the 180° peel strength between the roofing membrane 204 and the roofing substrate 202 is 20 PLI to 25 PLI when tested at 2″/min pulling speed in accordance with ASTM D413. In some embodiments, the 180° peel strength between the roofing membrane 204 and the roofing substrate 202 is 22 PLI to 25 PLI when tested at 2″/min pulling speed in accordance with ASTM D413. In some embodiments, the 180° peel strength between the roofing membrane 204 and the roofing substrate 202 is 24 PLI to 25 PLI when tested at 2″/min pulling speed in accordance with ASTM D413.

In some embodiments, the 180° peel strength of the adhesive is the 180° peel strength of the adhesive, when the adhesive is tested between the roofing membrane 204 and a plywood substrate. For example, in some embodiments, the 180° peel strength of the adhesive is the 180° peel strength of the adhesive, when the adhesive is located between the roofing membrane 204 and a plywood substrate, and when the adhesive is tested at a 2″/min pulling speed in accordance with ASTM D413. In some embodiments, the adhesive adheres the roofing membrane to the roofing substrate. In some embodiments, the adhesive comprises a sufficient amount of a fire retardant such that the adhesive, when installed on a plywood substrate, exhibits a 180° peel strength between the roofing membrane and the plywood substrate of at least 10 PLI when tested at a 2″/min pulling speed in accordance with ASTM D413.

In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 1% greater than a force required for a control adhesive, wherein the control adhesive does not comprise a fire retardant. In some embodiments, the roofing substrate 202 comprises a plywood substrate. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 5% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 10% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 15% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 20% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 25% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 30% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 35% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 40% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 45% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 50% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 55% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 60% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 65% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 70% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 75% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 80% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 85% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 90% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is at least 95% greater than a force required for a control adhesive, wherein the control adhesive does not comprise a fire retardant.

In some embodiments, In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is 1% to 100% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is 5% to 100%, 10% to 100%, 15% to 100%, 20% to 100%, 25% to 100%, 30% to 100%, 35% to 100%, 40% to 100%, 45% to 100%, 50% to 100%, 55% to 100%, 60% to 100%, 65% to 100%, 70% to 100%, 75% to 100%, 80% to 100%, 85% to 100%, 90% to 100%, 95% to 100% greater than a force required for a control adhesive, wherein the control adhesive does not comprise a fire retardant. In some embodiments, when the second layer 208 or the adhesive is located between the roofing membrane 204 and the roofing substrate 202, a force required to peel the roofing membrane 204 from the roofing substrate 202, at 180° at a 2″/min pulling speed in accordance with ASTM D413, is 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% greater than a force required for a control adhesive, wherein the control adhesive does not comprise a fire retardant. In some embodiments, the force required is the peel strength.

In some embodiments, the second layer 208 or the adhesive exhibits a burn time of less than 15 seconds when the second layer 208 is tested according to UL 94. In some embodiments, the second layer 208 exhibits a burn time of less than 14 seconds when the second layer 208 is tested according to UL 94. In some embodiments, the second layer 208 exhibits a burn time of less than 13 seconds when the second layer 208 is tested according to UL 94. In some embodiments, the second layer 208 exhibits a burn time of less than 12 seconds when the second layer 208 is tested according to UL 94. In some embodiments, the second layer 208 exhibits a burn time of less than 11 seconds when the second layer 208 is tested according to UL 94. In some embodiments, the second layer 208 exhibits a burn time of less than 10 seconds when the second layer 208 is tested according to UL 94. In some embodiments, the second layer 208 exhibits a burn time of less than 9 seconds when the second layer 208 is tested according to UL 94. In some embodiments, the second layer 208 exhibits a burn time of less than 8 seconds when the second layer 208 is tested according to UL 94. In some embodiments, the second layer 208 exhibits a burn time of less than 7 seconds when the second layer 208 is tested according to UL 94. In some embodiments, the second layer 208 exhibits a burn time of less than 6 seconds when the second layer 208 is tested according to UL 94. In some embodiments, the second layer 208 exhibits a burn time of less than 5 seconds when the second layer 208 is tested according to UL 94. In some embodiments, the second layer 208 exhibits a burn time of less than 4 seconds when the second layer 208 is tested according to UL 94. In some embodiments, the second layer 208 exhibits a burn time of less than 3 seconds when the second layer 208 is tested according to UL 94. In some embodiments, the second layer 208 exhibits a burn time of less than 2 seconds when the second layer 208 is tested according to UL 94. In some embodiments, the second layer 208 exhibits a burn time of less than 1 seconds when the second layer 208 is tested according to UL 94.

In some embodiments, the second layer 208 exhibits a burn time of 1 second to 15 seconds when the second layer 208 is tested according to UL 94. In some embodiments, the second layer 208 exhibits a burn time of 1 second to 14 seconds when the second layer 208 is tested according to UL 94. In some embodiments, the second layer 208 exhibits a burn time of 1 second to 13 seconds when the second layer 208 is tested according to UL 94. In some embodiments, the second layer 208 exhibits a burn time of 1 second to 12 seconds when the second layer 208 is tested according to UL 94. In some embodiments, the second layer 208 exhibits a burn time of 1 second to 11 seconds when the second layer 208 is tested according to UL 94. In some embodiments, the second layer 208 exhibits a burn time of 1 second to 10 seconds when the second layer 208 is tested according to UL 94. In some embodiments, the second layer 208 exhibits a burn time of 1 second to 9 seconds when the second layer 208 is tested according to UL 94. In some embodiments, the second layer 208 exhibits a burn time of 1 second to 8 seconds when the second layer 208 is tested according to UL 94. In some embodiments, the second layer 208 exhibits a burn time of 1 second to 7 seconds when the second layer 208 is tested according to UL 94. In some embodiments, the second layer 208 exhibits a burn time of 1 second to 6 seconds when the second layer 208 is tested according to UL 94. In some embodiments, the second layer 208 exhibits a burn time of 1 second to 5 seconds when the second layer 208 is tested according to UL 94. In some embodiments, the second layer 208 exhibits a burn time of 1 second to 4 seconds when the second layer 208 is tested according to UL 94. In some embodiments, the second layer 208 exhibits a burn time of 1 second to 3 seconds when the second layer 208 is tested according to UL 94. In some embodiments, the second layer 208 exhibits a burn time of 1 second to 2 seconds when the second layer 208 is tested according to UL 94.

In some embodiments, the second layer 208 exhibits a burn time of 1 second to 15 seconds when the second layer 208 is tested according to UL 94. In some embodiments, the second layer 208 exhibits a burn time of 2 second to 15 seconds when the second layer 208 is tested according to UL 94. In some embodiments, the second layer 208 exhibits a burn time of 3 second to 15 seconds when the second layer 208 is tested according to UL 94. In some embodiments, the second layer 208 exhibits a burn time of 4 second to 15 seconds when the second layer 208 is tested according to UL 94. In some embodiments, the second layer 208 exhibits a burn time of 5 second to 15 seconds when the second layer 208 is tested according to UL 94. In some embodiments, the second layer 208 exhibits a burn time of 6 second to 15 seconds when the second layer 208 is tested according to UL 94. In some embodiments, the second layer 208 exhibits a burn time of 7 second to 15 seconds when the second layer 208 is tested according to UL 94. In some embodiments, the second layer 208 exhibits a burn time of 8 second to 15 seconds when the second layer 208 is tested according to UL 94. In some embodiments, the second layer 208 exhibits a burn time of 9 second to 15 seconds when the second layer 208 is tested according to UL 94. In some embodiments, the second layer 208 exhibits a burn time of 10 second to 15 seconds when the second layer 208 is tested according to UL 94. In some embodiments, the second layer 208 exhibits a burn time of 11 second to 15 seconds when the second layer 208 is tested according to UL 94. In some embodiments, the second layer 208 exhibits a burn time of 12 second to 15 seconds when the second layer 208 is tested according to UL 94. In some embodiments, the second layer 208 exhibits a burn time of 13 second to 15 seconds when the second layer 208 is tested according to UL 94. In some embodiments, the second layer 208 exhibits a burn time of 14 second to 15 seconds when the second layer 208 is tested according to UL 94.

As used herein, a wind uplift resistance is measured according to “FM Approvals® method, Procedure Name: 12×24 ft Wind Uplift Tests using Positive Static Pressure, Procedure No: 4450, 4470, 4474, Revision No: 1 Date: Sep. 25, 2008” (hereinafter, “the 12×24 ft Wind Uplift Test”) at 23° C. and 50% relative humidity. The 12×24 ft Wind Uplift Test is incorporated herein by reference in its entirety for all purposes.

In some embodiments, the adhesive (or the second layer 208 of the roofing membrane 204) comprises a sufficient amount of a fire retardant such that the roofing system 200 exhibits a wind uplift resistance of 100 psf to 250 psf as measured according to the 12×24 ft Wind Uplift Test at 23° C. and 50% relative humidity. For example, in some embodiments, the roofing system 200 exhibits a wind uplift resistance of 100 psf to 240 psf as measured according to the 12×24 ft Wind Uplift Test at 23° C. and 50% relative humidity. In some embodiments, the roofing system 200 exhibits a wind uplift resistance of 100 psf to 230 psf as measured according to the 12×24 ft Wind Uplift Test at 23° C. and 50% relative humidity. In some embodiments, the roofing system 200 exhibits a wind uplift resistance of 100 psf to 220 psf as measured according to the 12×24 ft Wind Uplift Test at 23° C. and 50% relative humidity. In some embodiments, the roofing system 200 exhibits a wind uplift resistance of 100 psf to 210 psf as measured according to the 12×24 ft Wind Uplift Test at 23° C. and 50% relative humidity. In some embodiments, the roofing system 200 exhibits a wind uplift resistance of 100 psf to 200 psf as measured according to the 12×24 ft Wind Uplift Test at 23° C. and 50% relative humidity. In some embodiments, the roofing system 200 exhibits a wind uplift resistance of 100 psf to 190 psf as measured according to the 12×24 ft Wind Uplift Test at 23° C. and 50% relative humidity. In some embodiments, the roofing system 200 exhibits a wind uplift resistance of 100 psf to 180 psf as measured according to the 12×24 ft Wind Uplift Test at 23° C. and 50% relative humidity. In some embodiments, the roofing system 200 exhibits a wind uplift resistance of 100 psf to 170 psf as measured according to the 12×24 ft Wind Uplift Test at 23° C. and 50% relative humidity. In some embodiments, the roofing system 200 exhibits a wind uplift resistance of 100 psf to 160 psf as measured according to the 12×24 ft Wind Uplift Test at 23° C. and 50% relative humidity. In some embodiments, the roofing system 200 exhibits a wind uplift resistance of 100 psf to 150 psf as measured according to the 12×24 ft Wind Uplift Test at 23° C. and 50% relative humidity. In some embodiments, the roofing system 200 exhibits a wind uplift resistance of 100 psf to 140 psf as measured according to the 12×24 ft Wind Uplift Test at 23° C. and 50% relative humidity. In some embodiments, the roofing system 200 exhibits a wind uplift resistance of 100 psf to 130 psf as measured according to the 12×24 ft Wind Uplift Test at 23° C. and 50% relative humidity. In some embodiments, the roofing system 200 exhibits a wind uplift resistance of 100 psf to 102 psf as measured according to the 12×24 ft Wind Uplift Test at 23° C. and 50% relative humidity. In some embodiments, the roofing system 200 exhibits a wind uplift resistance of 100 psf to 110 psf as measured according to the 12×24 ft Wind Uplift Test at 23° C. and 50% relative humidity.

In some embodiments, the roofing system 200 exhibits a wind uplift resistance of 110 psf to 250 psf as measured according to the 12×24 ft Wind Uplift Test at 23° C. and 50% relative humidity. In some embodiments, the roofing system 200 exhibits a wind uplift resistance of 120 psf to 250 psf as measured according to the 12×24 ft Wind Uplift Test at 23° C. and 50% relative humidity. In some embodiments, the roofing system 200 exhibits a wind uplift resistance of 130 psf to 250 psf as measured according to the 12×24 ft Wind Uplift Test at 23° C. and 50% relative humidity. In some embodiments, the roofing system 200 exhibits a wind uplift resistance of 140 psf to 250 psf as measured according to the 12×24 ft Wind Uplift Test at 23° C. and 50% relative humidity. In some embodiments, the roofing system 200 exhibits a wind uplift resistance of 150 psf to 250 psf as measured according to the 12×24 ft Wind Uplift Test at 23° C. and 50% relative humidity. In some embodiments, the roofing system 200 exhibits a wind uplift resistance of 160 psf to 250 psf as measured according to the 12×24 ft Wind Uplift Test at 23° C. and 50% relative humidity. In some embodiments, the roofing system 200 exhibits a wind uplift resistance of 170 psf to 250 psf as measured according to the 12×24 ft Wind Uplift Test at 23° C. and 50% relative humidity. In some embodiments, the roofing system 200 exhibits a wind uplift resistance of 180 psf to 250 psf as measured according to the 12×24 ft Wind Uplift Test at 23° C. and 50% relative humidity. In some embodiments, the roofing system 200 exhibits a wind uplift resistance of 190 psf to 250 psf as measured according to the 12×24 ft Wind Uplift Test at 23° C. and 50% relative humidity. In some embodiments, the roofing system 200 exhibits a wind uplift resistance of 200 psf to 250 psf as measured according to the 12×24 ft Wind Uplift Test at 23° C. and 50% relative humidity. In some embodiments, the roofing system 200 exhibits a wind uplift resistance of 210 psf to 250 psf as measured according to the 12×24 ft Wind Uplift Test at 23° C. and 50% relative humidity. In some embodiments, the roofing system 200 exhibits a wind uplift resistance of 220 psf to 250 psf as measured according to the 12×24 ft Wind Uplift Test at 23° C. and 50% relative humidity. In some embodiments, the roofing system 200 exhibits a wind uplift resistance of 230 psf to 250 psf as measured according to the 12×24 ft Wind Uplift Test at 23° C. and 50% relative humidity. In some embodiments, the roofing system 200 exhibits a wind uplift resistance of 240 psf to 250 psf as measured according to the 12×24 ft Wind Uplift Test at 23° C. and 50% relative humidity.

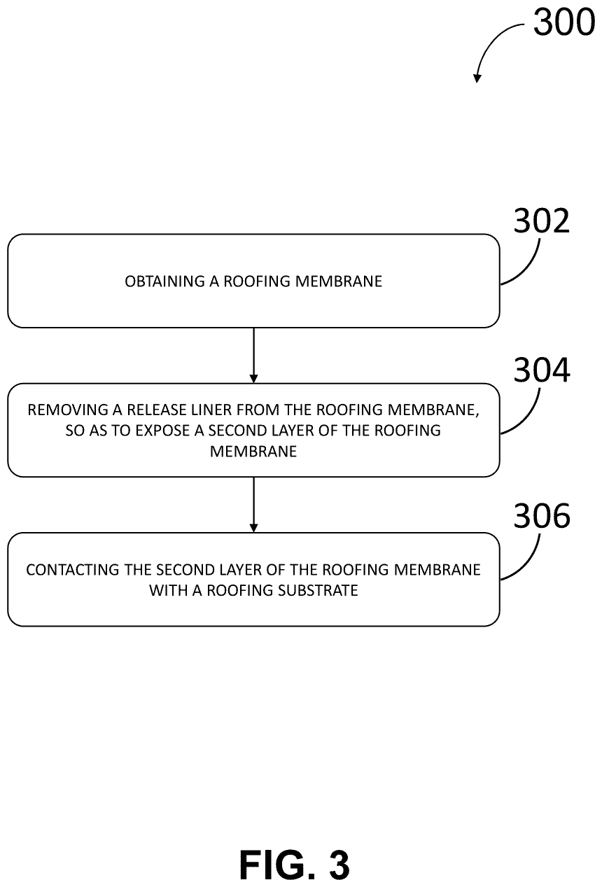

FIG. 3 is a flowchart of a method for installing a roofing membrane 300, according to some embodiments. As shown in FIG. 3, in some embodiments, the method for installing a roofing membrane 300 comprises one or more of the following steps: obtaining 302 a roofing membrane; removing 304 a release liner from the roofing membrane, so as to expose a second layer of the roofing membrane; and contacting 306 the second layer of the roofing membrane with a roofing substrate, so as to adhere the roofing membrane to the roofing substrate.

In some embodiments, the method for installing a roofing membrane 300 comprises obtaining 302 a roofing membrane. Any of the roofing membranes disclosed herein may be employed without departing from the scope of this disclosure. For example, in some embodiments, the roofing membrane comprises a first layer. In some embodiments, the roofing membrane comprises a second layer. In some embodiments, the roofing membrane comprises a release liner. In some embodiments, the second layer is located between the first layer and the release liner. In some embodiments, the release liner covers the second layer. In some embodiments, the second layer comprises an adhesive. In some embodiments, the adhesive comprises a fire retardant. For example, in some embodiments, the adhesive comprises 0.1% to 20% by weight of a fire retardant based on a total weight of the adhesive. In some embodiments, the step of obtaining the roofing membrane comprises unrolling a roll of the roofing membrane.

In some embodiments, the method for installing a roofing membrane 300 comprises removing 304 a release liner from the roofing membrane, so as to expose a second layer of the roofing membrane. In some embodiments, the removing 304 comprises peeling at least a portion of the release liner away from the roofing membrane so as to expose at least a portion of the second layer. In some embodiments, the removing 304 comprises pulling at least a portion of the release liner away from the roofing membrane so as to expose at least a portion of the second layer. In some embodiments, the removing 304 comprises disengaging at least a portion of the release liner away from the roofing membrane so as to expose at least a portion of the second layer. In some embodiments, the removing 304 comprises separating at least a portion of the release liner away from the roofing membrane so as to expose at least a portion of the second layer. In some embodiments, the removing 304 comprises delaminating at least a portion of the release liner away from the roofing membrane so as to expose at least a portion of the second layer.

In some embodiments, the method for installing a roofing membrane 300 comprises contacting 306 the second layer of the roofing membrane with a roofing substrate. In some embodiments, the contacting is sufficient to adhere the roofing membrane to the roofing substrate. In some embodiments, the contacting comprises bringing the second layer of the roofing membrane into immediate or close proximity to the roofing substrate. In some embodiments, the contacting comprises directly contacting the second layer of the roofing membrane with the roofing substrate. In some embodiments, the contacting comprises adhering the roofing membrane to the roofing substrate. In some embodiments, the contacting comprises pressing the roofing membrane onto the roofing substrate. In some embodiments, the contacting comprises rolling the roofing membrane onto the roofing substrate. In some embodiments, the contacting comprises heating the second layer of the roofing membrane sufficient to adhere to the roofing membrane to the roofing substrate. In some embodiments, the contacting comprises exposing the second layer of the roofing membrane to conditions sufficient to adhere the roofing membrane to the roofing substrate. In some embodiments, the contacting comprises irradiating the second layer of the roofing membrane to light (e.g., ultraviolet light) sufficient to adhere the roofing membrane to the roofing substrate.

In some embodiments, the method of installation further comprises curing the adhesive. In some embodiments, the curing comprises exposing the adhesive to ambient conditions for a duration sufficient to at least partially cure the adhesive. In some embodiments, the curing comprises heating the adhesive to a temperature sufficient to at least partially cure the adhesive. In some embodiments, the curing comprises exposing the adhesive to water moisture sufficient to at least partially cure the adhesive. In some embodiments, the curing comprises exposing the adhesive to light (e.g., ultraviolet light, visible light, infrared light, etc.) sufficient to at least partially cure the adhesive. In some embodiments, the curing comprises applying a stimulus or stimuli sufficient to induce curing. In some embodiments, the curing proceeds under conditions sufficient to at least partially cure the adhesive. In some embodiments, the curing proceeds under conditions sufficient to at least substantially cure the adhesive. In some embodiments, the curing proceeds under conditions sufficient to fully cure the adhesive.

In some embodiments, the curing is performed at a temperature of 20° C. to 40° C. In some embodiments, the curing is performed at a temperature of 20° C. to 38° C. In some embodiments, the curing is performed at a temperature of 20° C. to 36° C. In some embodiments, the curing is performed at a temperature of 20° C. to 35° C. In some embodiments, the curing is performed at a temperature of 20° C. to 34° C. In some embodiments, the curing is performed at a temperature of 20° C. to 32° C. In some embodiments, the curing is performed at a temperature of 20° C. to 30° C. In some embodiments, the curing is performed at a temperature of 20° C. to 28° C. In some embodiments, the curing is performed at a temperature of 20° C. to 26° C. In some embodiments, the curing is performed at a temperature of 20° C. to 25° C. In some embodiments, the curing is performed at a temperature of 20° C. to 24° C. In some embodiments, the curing is performed at a temperature of 20° C. to 22° C.

In some embodiments, the curing is performed at a temperature of 22° C. to 40° C. In some embodiments, the curing is performed at a temperature of 24° C. to 40° C. In some embodiments, the curing is performed at a temperature of 25° C. to 40° C. In some embodiments, the curing is performed at a temperature of 26° C. to 40° C. In some embodiments, the curing is performed at a temperature of 28° C. to 40° C. In some embodiments, the curing is performed at a temperature of 30° C. to 40° C. In some embodiments, the curing is performed at a temperature of 32° C. to 40° C. In some embodiments, the curing is performed at a temperature of 34° C. to 40° C. In some embodiments, the curing is performed at a temperature of 35° C. to 40° C. In some embodiments, the curing is performed at a temperature of 36° C. to 40° C. In some embodiments, the curing is performed at a temperature of 38° C. to 40° C.

Although the adhesives are described herein in connection with roofing membranes, it will be appreciated that the adhesives may be used in other roofing materials. As used herein, the term “roofing material” refers to a material configured to be installed on a roof. In some embodiments, the roofing material comprises at least one of a roofing membrane, a roofing underlayment, a roofing shingle, a roofing substrate, a roofing accessory, either in liquid form or solid form, or any combination thereof. It will further be appreciated that the adhesives may be used in other building materials. For example, the adhesives may be incorporated into building materials to adhere the building materials to a building structure. In some embodiments, the adhesives may be applied to a building structure to adhere a building material to the building structure. As used herein, a “building material” refers to a material that is, or is to be, installed on a building structure. As used herein, the term “building structure” refers to a component of a building. For example, in some embodiments, a building structure comprises at least one of a parapet wall, a roof substrate, a roof deck, a skylight, a roof edge, a building wall, a roof penetration, rough openings such as a window frame and/or a door frame, a seam between walls and other structures, a pipe, a corner, an edge, an overhang, a coating, a framing, a through-hole in a wall, or any combination thereof.

### Example 1

Various adhesive formulations were prepared and compared to control adhesive formulations. The control adhesive formulations included a first control adhesive composition (Control 1) and a second control adhesive composition (Control 2). The first control adhesive formulation was prepared without a fire retardant. The second control adhesive formulation was prepared with a conventional fire retardant. Three sample adhesive formulations were prepared, each with different fire retardants. Table 1 below summarizes the composition of the control adhesive formulation and the sample adhesive formulations. Table 2 below provides a summary of the fire retardant used in each of the adhesive formulations.

TABLE 1
Adhesive Formulations

| | Control Adhesive | Sample Adhesive |
|---|---|---|
| Component | Formulation | Formulations |
| Solvent(s) | 78% | 78% |
| Polychloroprene | 13% | 13% |
| Chlorinated Polyolefin | <1% | <1% |
| Fire Retardant(s) | 2% | 2% |
| Filler(s) | 1% | 1% |
| Additive(s) | 6% | 6% |
| Water | <1% | <1% |

TABLE 2
Fire Retardant Used in Adhesive Formulations

| Adhesive Formulation | Fire Retardant |
|---|---|
| Control 1 | None |
| Control 2 | Boric Acid |
| Sample 1 | Polyphosphate |
| Sample 2 | Magnesium Hydroxide |
| Sample 3 | Chlorinated Olefin |

The adhesion performance and fire performance of the various adhesive formulations was tested. For the adhesion performance, the control adhesive formulation and the sample adhesive formulations were applied between a roofing membrane and a roofing substrate, such that the roofing membrane was adhered to the roofing substrate. The roofing substrate was a plywood substrate. The adhesive formulations were allowed to cure for a period of 3 weeks at room temperature. To test the adhesion performance, the 180° peel strength between the roofing membrane and the roofing substrate was tested at a 2″/min pulling speed in accordance with ASTM D413. For the fire performance, the control adhesive formulation and the sample adhesive formulations were tested according to UL 94 and the burn time for each was measured. The peel strength (lbs/in) and burn time (seconds) for the control adhesive formulation and the sample adhesive formulations are summarized in Table 3 below.

TABLE 3
Peel Strength and Fire Resistance Performance

| Adhesive | | Peel Strength | Burn Time |
|---|---|---|---|
| Formulation | Fire Retardant | (lbs/in) | (seconds) |
| Control 1 | None | 18 | 20 |
| Control 2 | Boric Acid | 4 | 3 |
| Sample 1 | Polyphosphate | 20 | 8 |
| Sample 2 | Magnesium | 20 | 12 |
| | Hydroxide | | |
| Sample 3 | Chlorinated | 20 | 6 |
| | Olefin | | |

As shown in Table 3, the peel strength of the sample adhesive formulations—Sample 1, Sample 2, and Sample 3-improved relative to both control adhesive formulations (i.e., Control 1 and Control 2). With respect to burn time, the presence of the fire retardant in the adhesive improved the fire resistance performance of Samples 1 to 3 as demonstrated by the reduction in burn time.

### Example 2

Sample adhesive formulations were prepared with different amounts of the same fire retardant (chlorinated olefin). The adhesion performance and fire performance of the sample adhesive formulations were then tested. For the adhesion performance, the sample adhesive formulations were applied between a roofing membrane and a roofing substrate, such that the roofing membrane was adhered to the roofing substrate. The roofing substrate was a plywood substrate. The adhesive formulations were allowed to cure for a period of 3 weeks at room temperature. To test the adhesion performance, the 180° peel strength between the roofing membrane and the roofing substrate was tested at a 2″/min pulling speed in accordance with ASTM D413. For the fire performance, the sample adhesive formulations were tested according to UL 94 and the burn time for each was measured. The composition of the sample adhesive formulations, the peel strength (lbs/in), and the burn time (seconds) are summarized in Table 4 below.

TABLE 4
Fire Retardant Content, Peel Strength,
and Fire Resistance Performance

| Adhesive | Fire Retardant | Fire | Peel Strength | Burn Time |
|---|---|---|---|---|
| Formulation | Content (wt %) | Retardant | (lbs/in) | (seconds) |
| Sample 5 | 1% | Chlorinated | 25 | 6 |
| | | Olefin | | |
| Sample 6 | 2% | Chlorinated | 22 | 9 |
| | | Olefin | | |
| Sample 7 | 4% | Chlorinated | 18 | 9 |
| | | Olefin | | |
| Sample 8 | 6% | Chlorinated | 17 | 3 |
| | | Olefin | | |
| Sample 9 | 8% | Chlorinated | 23 | 0 |
| | | Olefin | | |
| Sample 10 | 10% | Chlorinated | 18 | 1 |
| | | Olefin | | |

As shown in Table 4, the peel strength of Samples 5 to 10 either exhibited improved peel strength or maintained peel strength, while also exhibited improved fire resistance performance, as demonstrated by reductions in burn time relative to the control adhesive formulation.

What is claimed is:

1. A roofing system comprising:
a roofing substrate; and
a roofing membrane;
wherein the roofing membrane is located on the roofing substrate;
wherein the roofing membrane comprises:
a first layer; and
a second layer;
wherein the second layer is located between the first layer and the roofing substrate;
wherein the second layer comprises an adhesive,
wherein the adhesive adheres the roofing membrane to the roofing substrate;
wherein the adhesive comprises 0.1% to 20% by weight of a fire retardant based on a total weight of the adhesive;
wherein:
A) when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant; or
B) the adhesive exhibits a burn time of less than 15 seconds when tested according to UL 94.

2. The roofing system of claim 1, wherein the first layer comprises a thermoplastic polyolefin (TPO), a polyvinyl chloride (PVC), or an ethylene propylene diene monomer (EPDM).

3. The roofing system of claim 1, wherein the adhesive comprises 0.1% to 15% by weight of the fire retardant based on a total weight of the adhesive.

4. The roofing system of claim 1, wherein the adhesive comprises 0.1% to 10% by weight of the fire retardant based on a total weight of the adhesive.

5. The roofing system of claim 1, wherein the adhesive comprises 0.1% to 5% by weight of the fire retardant based on a total weight of the adhesive.

6. The roofing system of claim 1, wherein the adhesive comprises a fire retardant selected from the group consisting of a polyphosphate, a magnesium hydroxide, a chlorinated olefin, an expandable graphite, an antimony trioxide, an alumina trihydrate, a zinc borate, and any combination thereof.

7. The roofing system of claim 1, when the adhesive is located between the roofing membrane and a plywood substrate, the force required to peel the roofing membrane from the plywood substrate, at 180° at a 2″/min pulling speed in accordance with ASTM D413, is 10% to 100% greater than a force required for a control adhesive, wherein the control adhesive does not comprise a fire retardant.

8. The roofing system of claim 1, wherein the second layer, when tested according to UL94, exhibits a burn time of 1 second to 15 seconds.

9. A roofing material comprising:
a roofing membrane; and
a second layer;
wherein, when the roofing membrane is installed on a roofing substrate, the second layer is located between the roofing membrane and the roofing substrate;
wherein the second layer comprises an adhesive,
wherein the adhesive comprises 0.1% to 20% by weight of a fire retardant based on a total weight of the adhesive;
wherein:
A) when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant; or
B) the adhesive exhibits a burn time of less than 15 seconds when tested according to UL 94.

10. The roofing material of claim 9, wherein the roofing material is in a form of a roll.

11. The roofing material of claim 9, wherein the roofing membrane comprises a thermoplastic polyolefin (TPO), a polyvinyl chloride (PVC), or an ethylene propylene diene monomer (EPDM).

12. The roofing material of claim 9, wherein the adhesive comprises 0.1% to 15% by weight of the fire retardant based on a total weight of the adhesive.

13. The roofing material of claim 9, wherein the adhesive comprises 0.1% to 10% by weight of the fire retardant based on a total weight of the adhesive.

14. The roofing material of claim 9, wherein the adhesive comprises a fire retardant selected from the group consisting of a polyphosphate, a magnesium hydroxide, a chlorinated olefin, an expandable graphite, an antimony trioxide, an alumina trihydrate, a zinc borate, and any combination thereof.

15. The roofing material of claim 9, when the adhesive is located between the roofing membrane and a plywood substrate, the force required to peel the roofing membrane from the plywood substrate, at 180° at a 2″/min pulling speed in accordance with ASTM D413, is 10% to 100% greater than a force required for a control adhesive, wherein the control adhesive does not comprise a fire retardant.

16. The roofing material of claim 9, wherein, when the roofing membrane is installed on a roofing substrate, the adhesive, when tested according to UL94, exhibits a burn time of 1 second to 15 seconds.

17. A method of installation comprising:
obtaining a roofing membrane,
wherein the roofing membrane comprises:
a first layer;
a second layer; and
a release liner;
wherein the second layer is located between the first layer and the release liner;
wherein the release liner covers the second layer;
wherein the second layer comprises an adhesive,
wherein the adhesive comprises 0.1% to 20% by weight of a fire retardant based on a total weight of the adhesive;
removing the release liner from the roofing membrane, so as to expose the second layer of the roofing membrane; and
contacting the second layer of the roofing membrane with a roofing substrate, so as to adhere the roofing membrane to the roofing substrate;
wherein:
A) when the adhesive is located between the roofing membrane and a plywood substrate, a force required to peel the roofing membrane from the plywood substrate, at 180° at a 2″/min pulling speed in accordance with ASTM D413, is at least 10% greater than a force required for a control adhesive, wherein the control adhesive does not comprise a fire retardant; or
B) the adhesive exhibits a burn time of less than 15 seconds when tested according to UL 94.

18. The method of claim 17, wherein the first layer comprises a thermoplastic polyolefin (TPO), a polyvinyl chloride (PVC), or an ethylene propylene diene monomer (EPDM).

19. The method of claim 17, wherein the adhesive comprises 0.1% to 15% by weight of the fire retardant based on a total weight of the adhesive.

20. The method of claim 17, wherein the adhesive comprises a fire retardant selected from the group consisting of a polyphosphate, a magnesium hydroxide, a chlorinated olefin, an expandable graphite, an antimony trioxide, an alumina trihydrate, a zinc borate, and any combination thereof.
